(19) United States
(12) Patent Application Publication
(10) Pub. No.: US 2026/0261044 A1
(43) Pub. Date: Sep. 3, 2026

(54) FEEDING STRUCTURE, FEEDING NETWORK, ANTENNA, AND BASE STATION

(71) Applicant: HUAWEI TECHNOLOGIES CO., LTD., Shenzhen (CN)

(72) Inventors: Guoyu Su, Shenzhen (CN); Wenyang Zhou, Shanghai (CN); Pengpeng Sun, Dongguan (CN); Jiachun Jiang, Dongguan (CN); Youbing Pan, Dongguan (CN)

(21) Appl. No.: 19/657,317

(22) Filed: Apr. 24, 2026

Related U.S. Application Data
(63) Continuation of application No. PCT/CN2024/099510, filed on Jun. 17, 2024.

(30) Foreign Application Priority Data
Oct. 27, 2023 (CN) 202311418212.7

(51) Int. Cl. H01Q 5/307; H01Q 3/34

(52) U.S. Cl. CPC H01Q 5/307; H01Q 3/34

(57) ABSTRACT

This disclosure provides a feeding structure, a feeding network, an antenna, and a base station. The feeding structure includes a first power division feedline, where the first power division feedline has a first port and at least two second ports; at least two baluns, where each balun includes a feeding body and a feeding pin, the feeding body is connected to the second port, and the feeding pin is disposed at an end that is of the feeding body and that is away from the second port; a power division isolation member, where a first power division isolation space is formed on the power division isolation member, and the first power division feedline is fastened to the first power division isolation member and is located in the first power division isolation space; and a balun isolation member, where a balun isolation space is formed on the balun isolation member.disclosure.

### CROSS-REFERENCE TO RELATED APPLICATIONS

This application is a continuation of International Application No. PCT/CN2024/099510, filed on June 17, 2024, which claims priority to Chinese Patent Application No.202311418212.7, filed on October 27, 2023. The disclosures of the aforementioned applications are hereby incorporated by reference in their entireties.

### TECHNICAL FIELD

This disclosure relates to the field of communication technologies, and in particular, to a feeding structure, a feeding network, an antenna, and a base station.

### BACKGROUND

A feeding network is usually disposed in a communication base station, and the feeding network includes a phase shifter, a power divider, a balun, and the like. The balun may be connected to an antenna element, to implement signal transmission between the balun and the antenna element.

In a related technology, both a power divider and a balun are microstrips, and the microstrip has a strong radiation field. In this case, when transmitting signals, the power divider and the balun are easily coupled to components around the feeding network in the base station, and a radiation loss is large. Consequently, radiation performance of the antenna element is affected.

### SUMMARY

To resolve the foregoing technical problem, this disclosure provides a feeding structure, a feeding network, an antenna, and a base station, to facilitate isolation between a first power division feedline and a balun in the feeding structure and a component in an external environment, thereby reducing a radiation loss.

This disclosure provides a feeding structure. The feeding structure may be used in a feeding network, and the feeding network may be applied to an antenna. In addition to the feeding network, the antenna may further include an antenna element electrically connected to the feeding network. The antenna may be used in a base station. In addition to the antenna, the base station may further include a receiver and a transmitter.

The feeding structure includes a first power division feedline, at least two baluns, a power division isolation member, and a balun isolation member. The first power division feedline has a first port and at least two second ports. Each balun includes a feeding body and a feeding pin, the feeding bodies of the at least two baluns are respectively connected to the at least two second ports, and the feeding pin is disposed at an end that is of the feeding body and that is away from the second port. A first power division isolation space is formed on the power division isolation member, and the first power division feedline is fastened to the first power division isolation member and is located in the first power division isolation space. A balun isolation space is formed on the balun isolation member, and the feeding body is fastened to the balun isolation member and is located in the balun isolation space.

When the feeding structure in this disclosure is used, the feeding pin may be electrically connected to the antenna element. The first port of the first power division feedline may be electrically connected to the receiver and the transmitter separately. In a process in which the antenna element radiates a signal, the transmitter may send the signal to the first port of the first power division feedline. The first power division feedline may divide the signal into a plurality of sub-signals, and transmit each sub-signal to the balun through the second port. Then, the signal is transmitted to the antenna element via the feeding pin of the balun, and is radiated via the antenna element. After the antenna element receives the signal, the antenna element may transmit the signal to the balun via the feeding pin. The signal is transmitted to the second port of the first power division feedline via the balun, transmitted to the first port through the first power division feedline, and transmitted from the first port to the receiver.

The power division isolation member has the first power division isolation space, and the first power division feedline is located in the first power division isolation space, so that the power division isolation member can provide isolation for the first power division feedline, to reduce coupling between the first power division feedline and a component in an external environment, thereby reducing a radiation loss. Similarly, the balun isolation space is formed on the balun isolation member, and the feeding body is located in the balun isolation space, so that the balun isolation member can provide isolation for the balun, to reduce coupling between the balun and the component in the external environment, thereby reducing the radiation loss.

In some implementations, the feeding structure further includes a second power division feedline, and the second power division feedline includes a first port and at least two second ports. A feeding body of a part of the at least two baluns is connected to the second port of the first power division feedline, and a feeding body of the other part of the baluns is connected to the second port of the second power division feedline. A second power division isolation space is formed on the power division isolation member, and the second power division feedline is fastened to the power division isolation member and is located in the second power division isolation space. When the antenna element is a dual-polarized antenna element, the feeding network needs to transmit signals in different polarization directions to the antenna element. In this implementation, the feeding structure further includes the second power division feedline, and the first power division feedline and the second power division feedline may respectively receive the signals that are sent by the transmitter and that are in different polarization directions. Therefore, the feeding structure in this disclosure may be used in a base station using the dual-polarized antenna element.

Based on this, the power division isolation member includes a first power division isolator and a second power division isolator, the first power division isolation space is formed on the first power division isolator, the second power division isolation space is formed on the second power division isolator, and the first power division isolator and the second power division isolator are disposed side by side. The first power division feedline and the first power division isolator may form a first power divider, and the second power division feedline and the second power division isolator may form a second power divider. The first power division isolator and the second power division isolator may respectively isolate the first power division feedline and the second power division feedline, to reduce a radiation loss between a sub-signal transmitted on the first power division feedline and a sub-signal transmitted on the second power division feedline.

In some implementations, the first power division isolator and the second power division isolator each include a first power division isolation part and a second power division isolation part that is disposed on the first power division isolation part and that forms, in an extension direction, an included angle with the first power division isolation part. The first power division feedline and the second power division feedline each include a signal transmission body and extension bodies respectively extending from two sides of the signal transmission body, the signal transmission bodies of the first power division feedline and the second power division feedline are respectively fastened to the first power division isolation parts of the first power division isolator and the second power division isolator, and the extension bodies of the first power division feedline and the second power division feedline are respectively fastened to the second power division isolation parts of the first power division isolator and the second power division isolator. In this way, the first power division isolation part can isolate the signal transmission body, and the second power division isolation part can isolate the extension body.

In some implementations, the first power division isolation part includes a first substrate and first side plates fastened to two sides of the first substrate, and the signal transmission body is located between the first substrate and the first side plates on the two sides. In this way, both the first substrate and the two first side plates can isolate the signal transmission body. In other words, the first power division isolation part can provide isolation in three directions for the signal transmission body. When the feeding structure is used, the feeding structure may be fastened to a circuit board over a phase-shifting power division network, so that the circuit board and the first substrate and the two first side plates of the first power division isolation part can provide isolation in four directions for the signal transmission body, thereby further reducing the radiation loss. In addition, a structure form between the signal transmission body and the first power division isolation part is a quasi-coaxial structure.

The second power division isolation part includes a second substrate and second side plates fastened to two sides of the second substrate, and the extension body is located between the second substrate and the second side plates of the second power division isolation part. In this way, both the first substrate and the two first side plates can isolate the extension body. In other words, the second power division isolation part can provide isolation in three directions for the extension body. When the feeding structure is used, the feeding structure may be fastened to the circuit board over the phase-shifting power division network, so that the circuit board and the first substrate and the two first side plates of the second power division isolation part can provide isolation in four directions for the extension body, thereby further reducing the radiation loss. In addition, a structure form between the extension body and the second power division isolation part is a quasi-coaxial structure.

For a connection relationship between the first power division isolator and the second power division isolator, in a possible implementation, two second side plates that are on the first power division isolator and the second power division isolator and that are close to each other are in contact and connected. In this case, the first power division isolator and the second power division isolator may be separately manufactured, and then the first power division isolator and the second power division isolator are fastened through bonding or soldering. In this way, one second side plate on the first power division isolator and one second side plate on the second power division isolator are both located between the first power division feedline and the second power division feedline, and both the two second side plates can isolate the first power division feedline and the second power division feedline, so that the radiation loss can be further reduced.

In another possible implementation, the power division isolation member further includes a connection plate, there is a distance between two second side plates that are on the first power division isolator and the second power division isolator and that are close to each other, and the two second side plates are connected via the connection plate. In this way, one second side plate on the first power division isolator and one second side plate on the second power division isolator are both located between the first power division feedline and the second power division feedline, and both the two second side plates can isolate the first power division feedline and the second power division feedline, so that the radiation loss between signals can be further reduced.

Based on this, the power division isolation member is of an integrally formed structure. In this way, strength of the power division isolation member can be improved.

The first power division isolator may be of an integrally formed structure, and the second power division isolator may also be of an integrally formed structure. In this way, to facilitate bending of the second power division isolator to form the two first side plates, a length of the first side plate is less than a length of the first substrate, and an end that is of the first side plate and that is away from the second power division isolation part is aligned with the first substrate. In other words, if there is a gap between the first side plate and the first power division isolator, the second power division isolator cannot provide isolation for the signal transmission body at the gap. Based on this, an end that is of the signal transmission body and that is close to the extension body is closer to the first substrate than an end that is of the signal transmission body and that is away from the extension body. In other words, the signal transmission body is closer to the first substrate. The end that is of the signal transmission body and that is away from the extension body needs to be connected to the circuit board over the phase-shifting power division network. When the signal transmission body is closer to the first substrate, it can be ensured that the end that is of the signal transmission body and that is away from the extension body is connected to the circuit board over the phase-shifting power division network, and the first substrate can provide better isolation for a part that is of the signal transmission body and that is closer to the first substrate.

Further, the signal transmission body includes a first connection part, a second connection part, and a signal input/output part that are sequentially connected, the first connection part is connected to the extension body, and a distance between the second connection part and the first substrate is less than a distance between the first connection part and the first substrate and is greater than a distance between the signal input/output part and the first substrate. The first connection part corresponds to the gap, and the first connection part is closest to the first substrate, so that isolation of the first substrate on the first connection part can be improved. The signal input/output part is farthest away from the first substrate, that is, the signal input/output part is closest to the bottom of the feeding structure, so that the signal input/output part is connected to the circuit board over the phase-shifting power division network. The second connection part further connects the first connection part to the signal input/output part, and when the distance between the second connection part and the first substrate is greater than the distance between the first connection part and the first substrate and is less than the distance between the signal input/output part and the first substrate, the second connection part may be located in the middle of the first side plate, so that isolation of the second power division isolation part on the signal transmission body is good.

In some implementations, a plurality of accommodation grooves are disposed on each of second side plates of the first power division isolator and the second power division isolator, a bottom pin is formed between two adjacent accommodation grooves on a same second side plate, and the accommodation groove is disposed on a side that is of the second side plate and that is away from the second substrate. When the feeding structure is used, the second side plate of the first power division isolation part needs to be soldered to the phase-shifting power division network. The bottom pin may be soldered to the phase-shifting power division network. For example, solder paste is applied to the bottom pin and the accommodation groove, and the solder paste is cured through reflow soldering. The accommodation groove can accommodate a large amount of solder paste, so that stability of soldering between the first power division isolation part and the phase-shifting power division network can be improved.

In some implementations, a connection groove is disposed on the side that is of the second side plate and that is away from the second substrate, a protrusion is disposed on a groove wall of the connection groove, and the protrusion and the groove wall form a clamping space. The feeding structure further includes a first fastener, and the first fastener includes a fastening body and a clamping part fastened to the fastening body. The first power division feedline and/or the second power division feedline are/is fastened to the first power division isolator and the second power division isolator via the first fastener, and the clamping part is clamped into the connection groove and is located in the clamping space. In this way, assembly between the signal transmission body, the first fastener, the first power division isolator, and the second power division isolator is more convenient, and a connection is more reliable.

In some implementations, the clamping part is a boss or an elastic arm. Therefore, the clamping part has a simple structure and is easy to implement.

In some implementations, grooves at corresponding locations are disposed on two opposite side surfaces of the extension body, so that the grooves on the extension body can implement impedance matching. Alternatively, grooves at corresponding locations are disposed on two opposite side surfaces of the feeding body, so that the grooves on the feeding body can implement impedance matching.

In some implementations, a limiting bump and a limiting groove are disposed on each of the first power division feedline and the second power division feedline; and a clamping groove is formed on the fastening body, the first fastener further includes a hook fastened to a groove wall of the clamping groove, the limiting bump is located in the clamping groove, and the hook is clamped on the limiting bump and is partially located in the limiting groove. In this way, the limiting groove and the limiting bump can limit the first fastener, so that the first power division feedline and the second power division feedline are fastened to the power division isolation member via the first fastener.

In some implementations, the feeding structure further includes a second fastener, the second fastener includes a fastening plate and a guide body fastened to the fastening plate, a plurality of through holes are disposed on the fastening plate, the fastening plate is fastened to the balun, and a part of the feeding pin penetrates the through hole and extends out of the fastening plate. In addition, a guide hole may be usually disposed on a bottom surface of the antenna element. In a process of mounting the antenna element on the feeding structure, a mounting location of the antenna on the feeding structure can be positioned via the guide body and the guide hole, to implement quick positioning. In addition, if there is no guide body, the mounting location of the antenna element needs to be positioned via the feeding pin, which causes the feeding pin to be damaged. Therefore, the feeding pin can be further protected by disposing the guide body.

In some implementations, the first power division feedline and the second power division feedline each include the signal transmission body and the extension bodies respectively extending from the two sides of the signal transmission body. The feeding structure further includes a first phase shift part, where the first phase shift part is fastened between the first power division feedline and the power division isolation member, the first phase shift part is further fastened between the second power division feedline and the power division isolation member, and the first phase shift part is configured to separately perform phase shift processing on signals transmitted on the first power division feedline and the second power division feedline. In this way, the first phase shift part can not only fasten the second power division feedline to the power division isolation member, but also has a phase shift function. In addition, the first phase shift part is located on one side of the signal transmission body, that is, a first phase shifter performs phase shift processing only on a signal transmitted by an extension body located on one side of the signal transmission body. In this way, a preset phase of the signal transmitted by the extension body on the one side relative to a signal transmitted by an extension body on the other side is implemented, thereby implementing a preset downtilt of an antenna radiation beam.

In some implementations, the feeding structure further includes a second phase shift part, the second phase shift part and the first phase shift part are located on a same side of the signal transmission body, the balun is fastened to the balun isolation member via the second phase shift part, and the second phase shift part is configured to perform phase shift processing on a signal transmitted on the balun. A phase shift amount of a phase shift part is related to a length of the phase shift part in a signal transmission direction. Because the first fastener is further fastened between the extension body and the power division isolation member, a length of the extension body in the signal transmission direction is limited, a length of the first phase shift part is limited, and a phase shift amount of the first phase shift part cannot meet a phase shift amount requirement. The second phase shift part can perform phase shift processing on the signal that is transmitted from the extension body to the balun and that is transmitted on the balun. Because the first phase shift part and the second phase shift part are located on the same side of the signal transmission body, phase shift processing can be separately performed on the signal transmitted on the balun via the first phase shift part and the second phase shift part, and a phase shift amount of the feeding structure is a sum of the phase shift amount of the first phase shift part and a phase shift amount of the second phase shift part. In this case, the phase shift amount of the feeding structure can be increased, thereby meeting the phase shift amount requirement.

There are a plurality of balun isolation members. The balun isolation member includes an isolation body. For a structure of the isolation body, in some possible implementations, the isolation body includes a third substrate and third side plates located on two sides of the third substrate, and third side plates of every two isolation bodies are disposed opposite to each other to form the balun isolation space. In this way, the isolation body has a simple structure and high strength. In this case, a quantity of balun isolation members is the same as a quantity of baluns.

In some other possible implementations, a cross section of the isolation body is a ring-shaped cross section having an opening, and each isolation body may form one balun isolation space. Therefore, the balun isolation member may use an integrally formed structure, so that strength of the balun isolation member can be improved.

In some other possible implementations, the balun isolation member further includes an isolation pin located at one end of the isolation body, and the feeding pin is disposed opposite to the isolation pin. In addition, a part of the isolation pin may also penetrate the through hole of the second fastener and extend out of the fastening plate. In this way, the second fastener can provide an auxiliary connection function for the balun and the balun isolation member. In addition, a fastening structure of the balun isolation member and the second fastener is simpler, and is easier to mount.

In some implementations, the first power division feedline and at least two baluns form an integrally formed structure. In this way, the first power division feedline and the at least two baluns can be manufactured together, so that a manufacturing process of the feeding structure can be simplified.

In some implementations, the power division isolation member and at least two balun isolation members form an integrally formed structure. In this way, the power division isolation member and the at least two balun isolation members can be manufactured together, so that the manufacturing process of the feeding structure can be simplified.

According to a second aspect of this disclosure, a feeding network is further provided, including a circuit board, a phase-shifting power division network, and the feeding structure according to any one of the foregoing implementations. The phase-shifting power division network is electrically connected to the circuit board, and the feeding structure is electrically connected to the phase-shifting power division network. The feeding network can implement all effect of the feeding structure.

According to a third aspect of this disclosure, an antenna is further provided, including a plurality of antenna elements and the feeding network. The antenna element is electrically connected to the feeding network. The antenna can implement all effect of the feeding network.

According to a fourth aspect of this disclosure, a base station is further provided, including a receiver, a transmitter, and the antenna. Both the receiver and the transmitter are electrically connected to the antenna. The base station can implement all effect of the antenna.

### BRIEF DESCRIPTION OF DRAWINGS

To describe technical solutions in embodiments of this disclosure more clearly, the following briefly introduces accompanying drawings used in describing embodiments of this disclosure. It is clear that the accompanying drawings in the following descriptions show merely some embodiments of this disclosure, and a person of ordinary skill in the art may still derive other drawings from these accompanying drawings without creative efforts.

FIG. 1 is a diagram of a structure of a base station according to an embodiment of this disclosure;

FIG. 2a is a diagram of a location relationship between an antenna element on a first frequency band and an antenna element on a second frequency band in FIG. 1;

FIG. 2b is a diagram of a structure of a connection between an antenna element on a first frequency band and a feeding network in a related technology;

FIG. 3 is a diagram of a structure of a connection between a feeding network and an antenna element according to an embodiment of this disclosure;

FIG. 4 is a top view of the embodiment shown in FIG. 3;

FIG. 5 is a diagram of a three-dimensional structure of a feeding structure shown in FIG. 3;

FIG. 6 is a diagram of an exploded structure of the feeding structure shown in FIG. 5;

FIG. 7 is a diagram of a structure of a connection between a first power division isolator and a balun isolation member in FIG. 5;

FIG. 8 is a diagram of a structure of a connection between a second power division isolator and a balun isolation member in FIG. 5;

FIG. 9 is a diagram 1 of a partial structure of FIG. 7;

FIG. 10 is a diagram 1 of a partial structure of FIG. 8;

FIG. 11 is a diagram 2 of a partial structure of FIG. 7;

FIG. 12 is a diagram 2 of a partial structure of FIG. 8;

FIG. 13 is a diagram 3 of a partial structure of FIG. 7;

FIG. 14 is a diagram 3 of a partial structure of FIG. 8;

FIG. 15 is a diagram 4 of a partial structure of FIG. 7;

FIG. 16 is a diagram 4 of a partial structure of FIG. 8;

FIG. 17 is a diagram of a structure of a connection between a first power division feedline and a balun in FIG. 5;

FIG. 18 is a diagram of a structure of a connection between a second power division feedline and a balun in FIG. 5;

FIG. 19 is a diagram 1 of a partial structure of FIG. 17;

FIG. 20 is a diagram 1 of a partial structure of FIG. 18;

FIG. 21 is a diagram 2 of a partial structure of FIG. 17;

FIG. 22 is a diagram 2 of a partial structure of FIG. 18;

FIG. 23 is a diagram 3 of a partial structure of FIG. 17;

FIG. 24 is a diagram 3 of a partial structure of FIG. 18;

FIG. 25 is a diagram 4 of a partial structure of FIG. 17;

FIG. 26 is a diagram 4 of a partial structure of FIG. 18;

FIG. 27 is a diagram of a structure of a first fastener in FIG. 5;

FIG. 28 is a diagram of a structure of a third fastener in FIG. 5;

FIG. 29 is a diagram of a structure of a second fastener in FIG. 5;

FIG. 30 is a diagram of a structure of a fourth fastener in FIG. 5;

FIG. 31 is a diagram of a structure of a first phase shift part in FIG. 5;

FIG. 32 is a diagram of a structure of a second phase shift part in FIG. 5;

FIG. 33 is a diagram of a three-dimensional structure of a feeding structure according to a second embodiment of this disclosure;

FIG. 34 is a diagram of an exploded structure of the feeding structure shown in FIG. 33;

FIG. 35 is a diagram of a structure of a power division isolation member in FIG. 33;

FIG. 36 is a diagram 1 of a partial structure of FIG. 35;

FIG. 37 is a diagram 1 of a partial structure of FIG. 35;

FIG. 38 is a diagram 2 of a partial structure of FIG. 35;

FIG. 39 is a diagram 2 of a partial structure of FIG. 35;

FIG. 40 is a diagram of a structure of a balun isolation member in FIG. 33;

FIG. 41 is a diagram of a structure of a connection between a second power division feedline and a balun in FIG. 33;

FIG. 42 is a diagram 1 of a partial structure of FIG. 41;

FIG. 43 is a diagram 1 of a partial structure of FIG. 41;

FIG. 44 is a diagram of a structure of a first fastener in FIG. 33;

FIG. 45 is a diagram of a structure of a third fastener in FIG. 33;

FIG. 46 is a diagram of a structure of a second fastener in FIG. 33;

FIG. 47 is a diagram of a structure of a first phase shift part in FIG. 33; and

FIG. 48 is a diagram of a structure of a second phase shift part in FIG. 33.

Reference numerals: 1: antenna; 2: receiver; 3: transmitter; 200: antenna element; 100: feeding network; 101: phase-shifting power division network; 102: feeding structure; 1021: phase shifter; 1022: power divider; 1023: transmission line; 10: first power division feedline; 20: second power division feedline; 11: first port; 12: second port; 13: signal transmission body; 131: first connection part; 132: second connection part; 133: signal input/output part; 134: limiting groove; 14: extension body; 141: groove; 30: balun; 31: feeding body; 311: first feeding part; 312: second feeding part; 313: limiting bump; 32: feeding pin; 40: power division isolation member; 41: first power division isolation space; 42: second power division isolation space; 43: first power division isolator; 44: second power division isolator; 45: connection plate; 46: identification part; 431: first power division isolation part; 4311: first substrate; 4312: first side plate; 432: second power division isolation part; 4321: second substrate; 4322: second side plate; 4323: accommodation groove; 4324: bottom pin; 4325: process hole; 4326: connection groove; 4327: protrusion; 4328: clamping space; 4329: avoidance groove; 434: top opening; 433: side opening; 50: balun isolation member; 51: isolation body; 511: hook groove; 512: third substrate; 513: third side plate; 52: isolation pin; 53: balun isolation space; 54: isolation soldering pin; 61: first fastener; 611: fastening body; 6111: clamping groove; 612: clamping part; 613: hook; 62: second fastener; 621: fastening plate; 6211: through hole; 622: guide body; 623: boss; 63: third fastener; 64: fourth fastener; 70: first phase shift part; 71: phase shift body; 711: phase shift groove; 72: baffle; and 80: second phase shift part.

### DESCRIPTION OF EMBODIMENTS

The following clearly describes technical solutions in embodiments of this disclosure with reference to accompanying drawings in embodiments of this disclosure. It is clear that described embodiments are some but not all of embodiments of this disclosure. Based on embodiments of this disclosure, all other embodiments obtained by a person of ordinary skill in the art without creative efforts fall within the protection scope of this disclosure.

A term "and/or" in this specification describes only an association relationship between associated objects and indicates that three relationships may exist. For example, A and/or B may indicate the following three cases: Only A exists, both A and B exist, and only B exists, where A and B may be singular or plural. A character "/" usually indicates an "or" relationship between the associated objects. "At least one piece (item)" means one or more, and "a plurality of" means two or more. "At least one of the following items (pieces)" or a similar expression thereof means any combination of the items, and includes a single item (piece) or any combination of a plurality of items (pieces). For example, at least one of a, b, or c may indicate a, b, c, "a and b", "a and c", "b and c", or "a, b, and c", where a, b, and c may be singular, or plural.

In the specification and the claims in embodiments of this disclosure, terms "first", "second", and the like are intended to distinguish between different objects, but do not indicate a specific order of the objects. For example, a first target object and a second target object are intended to distinguish between different target objects, but do not indicate a specific order of the target objects.

Terms such as "connection", "connected", and the like are used for indicating interworking or mutual interaction between different components, and may include a direct connection or an indirect connection via another component. In addition, terms "include", "have", and any variant thereof are intended to cover non-exclusive inclusion, for example, include a series of steps or units. A method, system, product, or device is not necessarily limited to those steps or units expressly listed, but may include other steps or units not expressly listed or inherent to such a process, method, product, or device. "Up", "down", "left", "right", and the like are used only relative to orientations of components in the accompanying drawings. These directional terms are relative concepts, are used for relative descriptions and clarifications, and may change accordingly as locations at which the components in the accompanying drawings are placed change.

In addition, in embodiments of this disclosure, a word "example", "for example", or the like indicates giving an example, an illustration, or a description. Any embodiment or design scheme described as an "example" or "for example" in embodiments of this disclosure should not be explained as being more preferred or having more advantages than another embodiment or design scheme. Exactly, use of the word "example", "for example", or the like is intended to present a related concept in a specific manner.

In descriptions of embodiment of this disclosure, unless otherwise stated, "a plurality of" means two or more. For example, a plurality of processing units mean two or more processing units, and a plurality of systems mean two or more systems.

A base station usually includes a receiver 2, a transmitter 3, and an antenna 1 shown in FIG. 1. Both the receiver 2 and the transmitter 3 are electrically connected to the antenna 1. The antenna 1 is a basis of current mobile communication, and plays an important role in mobile communication. To meet people's increasing requirements for a rate and a bandwidth of the mobile communication, a communication system with a higher rate and a larger capacity needs to be designed. The antenna 1 evolves from a 4th-generation (4G) mobile communication technology to a 5th-generation (5G) mobile communication technology.

As shown in FIG. 1, the antenna 1 includes a plurality of antenna elements 200 and a feeding network 100. The plurality of antenna elements 200 are all electrically connected to the feeding network 100. The feeding network 100 is further electrically connected to the receiver 2, and the feeding network 100 is further electrically connected to the transmitter 3. The feeding network 100 may receive a signal sent by the transmitter 3, properly allocate an amplitude and a phase of the signal, and then transmit the signal to each antenna element 200, to control a beam for transmitting the signal by the antenna 1. Certainly, each antenna element 200 may alternatively receive a signal, and send the signal to the receiver 2. Therefore, the feeding network 100 is an important part of the antenna 1. Highly integrated, low-cost, and miniaturized arrangement of the feeding network 100 in the antenna 1 is an inevitable trend of evolution of the antenna 1.

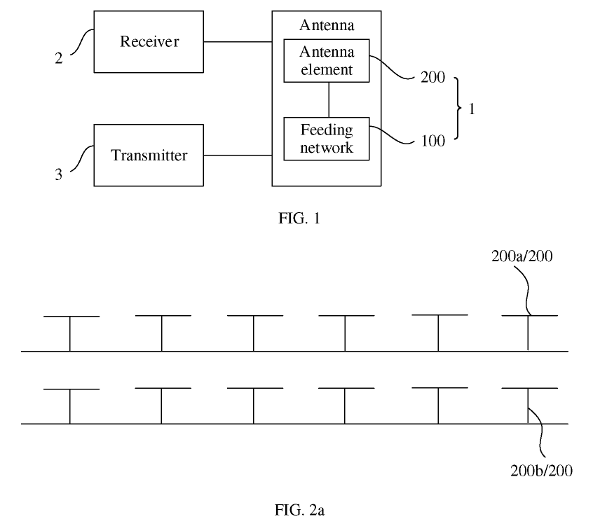

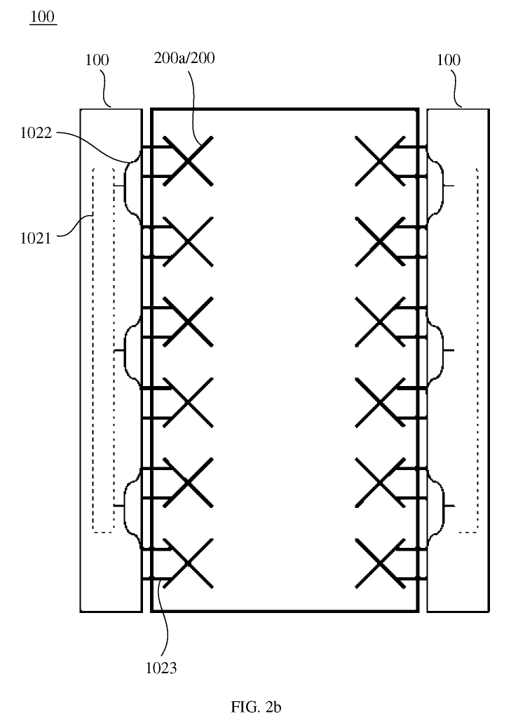

In a related technology, as shown in FIG. 2a, the antenna element 200 in the antenna 1 includes an antenna element 200a on a first frequency band and an antenna element 200b on a second frequency band. To implement an integrated design, the antenna element 200b on the second frequency band is usually disposed below the antenna element 200a on the first frequency band. To reduce impact of the antenna element 200a on the first frequency band on signal radiation and receiving of the antenna element 200b on the second frequency band, as shown in FIG. 2b, the feeding network 100 is disposed on two sides of the antenna element 200a on the first frequency band.

As shown in FIG. 2b, the feeding network 100 includes a circuit board (not shown in FIG. 2b) and a feeding structure 102 fastened to the circuit board. The feeding structure 102 includes a phase shifter 1021, a power divider 1022, a transmission line 1023, and a balun (not shown in FIG. 2b). The phase shifter 1021 is electrically connected to the circuit board, the phase shifter 1021 is electrically connected to the power divider 1022, the power divider 1022 is electrically connected to the balun through the transmission line 1023, and the balun is electrically connected to the antenna element 200a on the first frequency band. The phase shifter 1021 is further connected to the transmitter 3. In this way, a signal transmitted by the transmitter 3 can be sequentially transmitted to the antenna element 200 on the first frequency band via the phase shifter 1021, the power divider 1022, the transmission line 1023, and the balun, and radiated via the antenna element 200a on the first frequency band.

Because the feeding network 100 is located on the two sides of the antenna element 200a on the first frequency band, a horizontal size of the feeding network 100 is large, and signal radiation of the antenna element 200b on the second frequency band is also blocked. In addition, because there are excessive manual solder joints between the transmission line 1023 and the balun, an SMT reflow soldering manner is not supported. When the transmission line 1023 is a microstrip, a transmission loss is high. To reduce the transmission loss, a microstrip of a multi-layer radio frequency board structure may be used, which results in high costs. The power divider 1022 is usually implemented via a PCB board, which makes it hard to perform SMT reflow soldering and assembly complex.

To resolve the foregoing problem, in another related technology, the balun and the power divider 1022 are made into an integrated structure. In this way, the transmission line 1023 does not need to be used. However, both the power divider 1022 and the balun are microstrips, and the microstrip has a strong radiation field. In this case, when transmitting signals, the power divider 1022 and the balun are easily coupled to components around the feeding network 100 in the base station, and a radiation loss is large. Consequently, radiation performance of the antenna element 200 is affected.

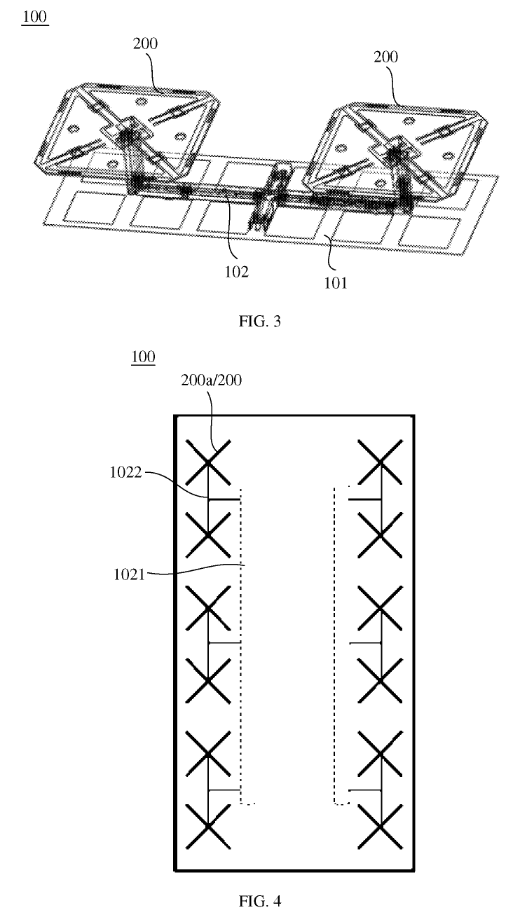

In view of this, an embodiment of this disclosure provides a feeding network 100. As shown in FIG. 3, the feeding network 100 includes a circuit board (not shown in FIG. 3), a phase-shifting power division network 101, and a feeding structure 102. The phase-shifting power division network 101 is electrically connected to the circuit board, and the feeding structure 102 is electrically connected to the phase-shifting power division network 101. To be specific, the bottom of the feeding structure 102 is attached to the phase-shifting power division network 101, and the phase-shifting power division network 101 is mounted on the circuit board. As shown in FIG. 4, the phase-shifting power division network 101 may be located between two groups of opposite antenna elements 200.

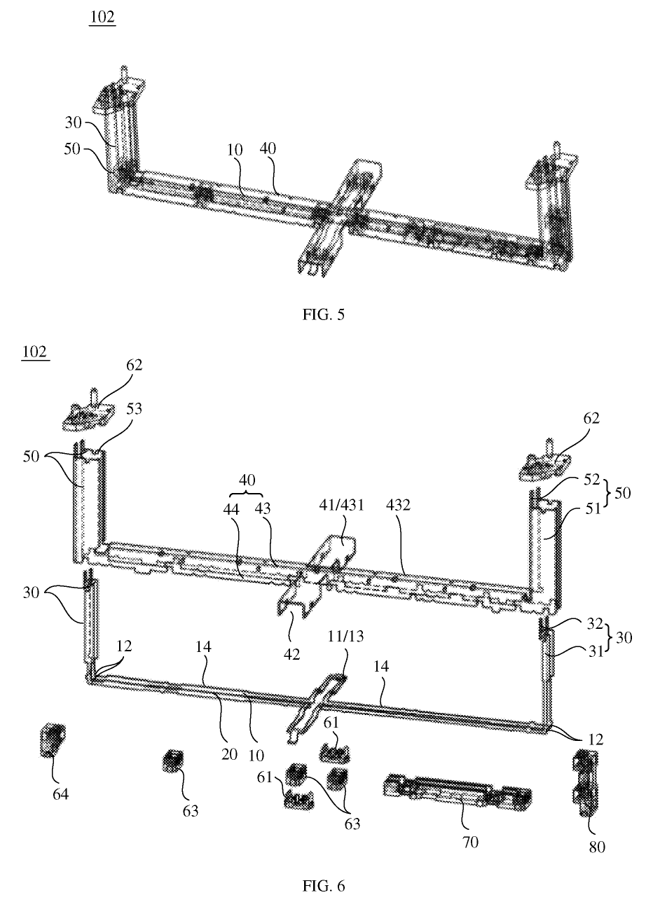

As shown in FIG. 5 and FIG. 6, the feeding structure 102 includes a first power division feedline 10, at least two baluns 30, a power division isolation member 40, and a balun isolation member 50.

As shown in FIG. 6, the first power division feedline 10 has a first port 11 and at least two second ports 12. For example, the first power division feedline 10 in this embodiment includes two second ports 12. A first power division isolation space 41 is formed on the power division isolation member 40, and the first power division feedline 10 is fastened to the first power division isolation member 40 and is located in the first power division isolation space 41.

As shown in FIG. 6, each balun 30 includes a feeding body 31 and a feeding pin 32, one end of the feeding body 31 is connected to the second port 12, and the feeding pin 32 is disposed at an end that is of the feeding body 31 and that is away from the second port 12. The balun isolation member 50 includes an isolation body 51 and an isolation pin 52 located at an end of the isolation body 51, a balun isolation space 53 is formed on the isolation body 51, the feeding body 31 is fastened to the balun isolation member 50 and is located in the balun isolation space 53, and the feeding pin 32 and the isolation pin 52 are disposed opposite to each other.

When the feeding structure 102 in this embodiment of this disclosure is used, the feeding pin 32 may be electrically connected, by using soldering tin, to a soldering pad on a radiation surface of the antenna element 200a on the first frequency band shown in FIG. 4. The first port 11 of the first power division feedline 10 may be electrically connected to the receiver 2 and the transmitter 3 shown in FIG. 1 separately. In a process in which the antenna element 200 radiates a signal, the transmitter 3 may send the signal to the first port 11 of the first power division feedline 10. The first power division feedline 10 may divide the signal into a plurality of sub-signals, and transmit each sub-signal to the balun 30 through the second port 12. Then, the signal is transmitted to the antenna element 200 via the feeding pin 32 of the balun 30, and is radiated via the antenna element 200. After the antenna element 200 receives the signal, the antenna element 200 may transmit the signal to the balun 30 via the feeding pin 32. The signal is transmitted to the second port 12 of the first power division feedline 10 via the balun 30, transmitted to the first port 11 through the first power division feedline 10, and transmitted from the first port 11 to the receiver 2.

The power division isolation member 40 has the first power division isolation space 41, and the first power division feedline 10 is located in the first power division isolation space 41, so that the power division isolation member 40 can provide isolation for the first power division feedline 10, to reduce coupling between the first power division feedline 10 and a component in an external environment, thereby reducing a radiation loss. Similarly, the balun isolation space 53 is formed on the balun isolation member 50, and the feeding body 31 is located in the balun isolation space 53, so that the balun isolation member 50 can provide isolation for the balun 30, to reduce coupling between the balun 30 and the component in the external environment, thereby reducing the radiation loss. Therefore, impact on signal radiation by the antenna element 200 can be reduced.

In addition, in this embodiment, the balun 30 is connected to the first power division feedline 10, and the transmission line 1023 is not required. Therefore, advantages such as integration and miniaturization can be implemented. The feeding structure 102 is located below the antenna element 200, so that a horizontal size of the antenna can be reduced. The feeding network 100 is of a frame structure as a whole. This can further reduce blocking on the antenna element 200b on the second frequency band, to reduce impact on signal radiation performance of the antenna element 200b on the second frequency band. Both the feeding structure 102 and the antenna element 200 and the feeding structure 102 and the phase-shifting power division network 101 may be soldered in an SMT reflow soldering manner. In addition, the balun 30, the first power division feedline 10, the power division isolation member 40, and the balun isolation member 50 each may be made of a conductive material, for example, a metal material, a material like copper or aluminum. In this way, because no microstrip needs to be used in this embodiment, a transmission loss and costs can be reduced.

As shown in FIG. 6, the feeding structure 102 may further include a second power division feedline 20, and a structure of the second power division feedline 20 may be the same as a structure of the first power division feedline 10. For example, the second power division feedline 20 may also include a first port 11 and two second ports 12. The second power division feedline 20 may alternatively be a one-to-two power divider 1022.

As shown in FIG. 6, a feeding body 31 of a part of the at least two baluns 30 is connected to the second port 12 of the first power division feedline 10, and a feeding body 31 of the other part of the baluns 30 is connected to the second port 12 of the second power division feedline 20. For example, in this embodiment, the feeding structure 102 includes four baluns 30. Ends of two of the baluns 30 are respectively connected to the two second ports 12 of the first power division feedline 10, and ends of the other two baluns 30 are respectively connected to the two second ports 12 of the second power division feedline 20.

As shown in FIG. 6, a second power division isolation space 42 is further formed on the power division isolation member 40, and the second power division feedline 20 is fastened to the power division isolation member 40 and is located in the second power division isolation space 42. When the antenna element 200 is a dual-polarized antenna element 200, the feeding network 100 needs to transmit signals in different polarization directions to the antenna element 200. In this embodiment, the feeding structure 102 further includes the second power division feedline 20, and the first power division feedline 10 and the second power division feedline 20 may respectively receive the signals that are sent by the transmitter 3 and that are in different polarization directions. Therefore, the feeding structure 102 in this disclosure may be used in a base station using the dual-polarized antenna element 200.

Based on this, as shown in FIG. 6, the power division isolation member 40 includes a first power division isolator 43 and a second power division isolator 44, the first power division isolation space 41 is formed on the first power division isolator 43, the second power division isolation space 42 is formed on the second power division isolator 44, and the first power division isolator 43 and the second power division isolator 44 are disposed side by side. The first power division feedline 10 and the first power division isolator 43 may form a first power divider. In addition, because the first power division feedline 10 has the two second ports 12, the first power divider in this embodiment is a one-to-two power divider. The second power division feedline 20 and the second power division isolator 44 may form a second power divider. Similarly, the second power divider may also be a one-to-two power divider. In this way, the first power division isolator 43 and the second power division isolator 44 can respectively isolate the first power division feedline 10 and the second power division feedline 20, to reduce a radiation loss between a sub-signal transmitted on the first power division feedline 10 and a sub-signal transmitted on the second power division feedline 20.

As shown in FIG. 7, the first power division isolator 43 includes a first power division isolation part 431 and a second power division isolation part 432. The second power division isolation part 432 is disposed on the first power division isolation part 431, and forms, in an extension direction, an included angle with the first power division isolation part 431.

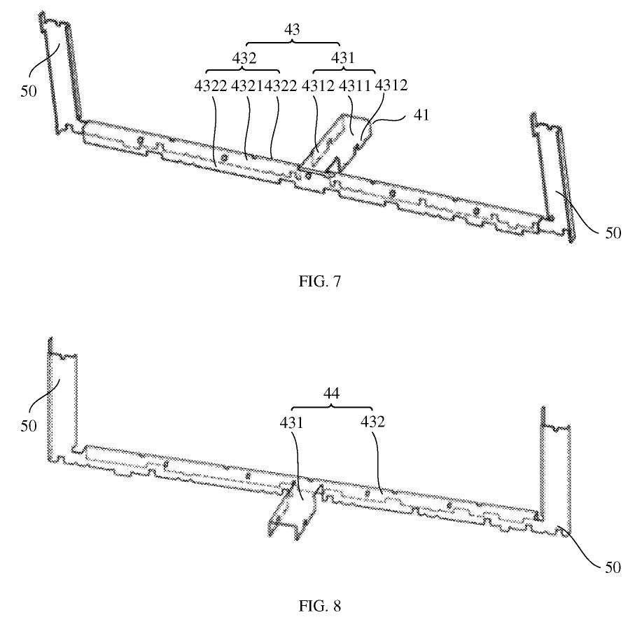

As shown in FIG. 8, the second power division isolator 44 and the first power division isolator 43 have a same structure and are disposed opposite to each other. For example, the second power division isolator 44 also includes a first power division isolation part 431 and a second power division isolation part 432. The second power division isolation part 432 is disposed on the first power division isolation part 431, and forms, in an extension direction, an included angle with the first power division isolation part 431. The first power division isolation part 431 of the first power division isolator 43 and the first power division isolation part 431 of the second power division isolator 44 are disposed in a direction away from each other.

As shown in FIG. 7, the first power division isolation part 431 may include a first substrate 4311 and first side plates 4312 fastened to two sides of the first substrate 4311. The first substrate 4311 and the two first side plates 4312 may form a "U"-shaped structure.

As shown in FIG. 7, the second power division isolation part 432 may include a second substrate 4321 and second side plates 4322 fastened to two sides of the second substrate 4321. The second substrate 4321 and the two second side plates 4322 may form a "U"-shaped structure. An area enclosed between the first substrate 4311 and the two first side plates 4312 of the first power division isolator 43 and an area enclosed between the second substrate 4321 and the two second side plates 4322 of the first power division isolator 43 are the first power division isolation space 41. Similarly, an area enclosed between the first substrate 4311 and the two first side plates 4312 of the second power division isolator 44 and an area enclosed between the second substrate 4321 and the two second side plates 4322 of the second power division isolator 44 are the second power division isolation space 42.

As shown in FIG. 6, in this embodiment, two second side plates 4322 that are on the first power division isolator 43 and the second power division isolator 44 and that are close to each other are in contact and connected. In this case, the first power division isolator 43 and the second power division isolator 44 may be separately manufactured, and then the first power division isolator 43 and the second power division isolator 44 are fastened through bonding or soldering. In this way, one second side plate 4322 on the first power division isolator 43 and one second side plate 4322 on the second power division isolator 44 are both located between the first power division feedline 10 and the second power division feedline 20, and both the two second side plates 4322 can isolate the first power division feedline 10 and the second power division feedline 20, so that the radiation loss can be further reduced. In another embodiment, the two second side plates 4322 that are on the first power division isolator 43 and the second power division isolator 44 and that are close to each other are in contact but are not connected. Alternatively, there is a gap between the two second side plates 4322 that are on the first power division isolator 43 and the second power division isolator 44 and that are close to each other.

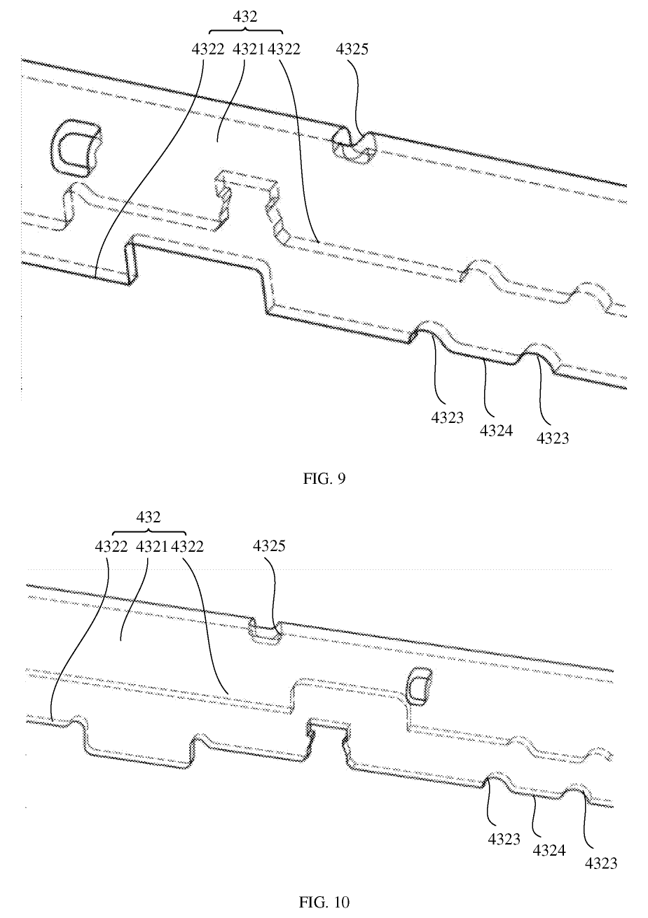

As shown in FIG. 9 and FIG. 10, a plurality of accommodation grooves 4323 are disposed on each of second side plates 4322 of the first power division isolator 43 and the second power division isolator 44, a bottom pin 4324 is formed between two adjacent accommodation grooves 4323 on a same second side plate 4322, and the accommodation groove 4323 is disposed on a side that is of the second side plate 4322 and that is away from the second substrate 4321. When the feeding structure 102 is used, the second side plate 4322 of the first power division isolation part 431 needs to be soldered to the phase-shifting power division network 101. The bottom pin 4324 may be soldered to the phase-shifting power division network 101. For example, solder paste is applied to the bottom pin 4324 and the accommodation groove 4323, and the solder paste is cured through reflow soldering. The accommodation groove 4323 can accommodate a large amount of solder paste, so that stability of soldering between the first power division isolation part 431 and the phase-shifting power division network 101 can be improved.

As shown in FIG. 9 and FIG. 10, a process hole 4325 is disposed at a joint between the second substrate 4321 and the second side plate 4322. In this way, it is convenient to bend sheet metal to form the first power division isolator 43.

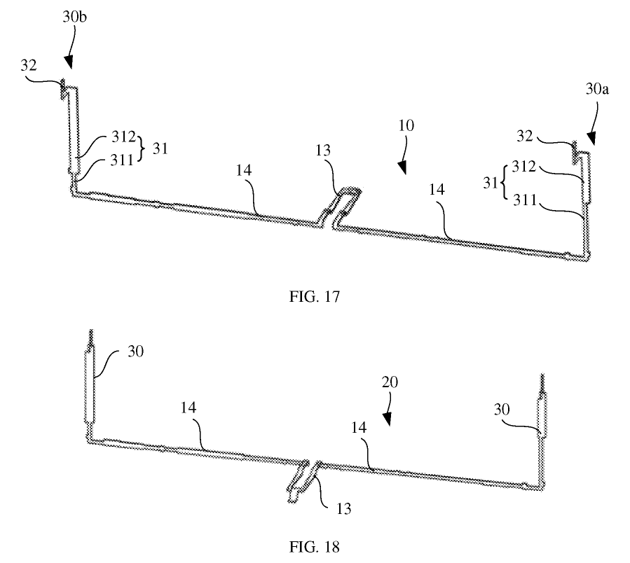

As shown in FIG. 17 and FIG. 18, the first power division feedline 10 and the second power division feedline 20 each may include a signal transmission body 13 and extension bodies 14 respectively extending from two sides of the signal transmission body 13. An end that is of the extension body 14 and that is away from the signal transmission body 13 is connected to an end of the balun 30.

As shown in FIG. 6, the signal transmission body 13 of the first power division feedline 10 is fastened to the first power division isolation part 431 of the first power division isolator 43. For example, the signal transmission body 13 of the first power division feedline 10 is fastened between the first substrate 4311 and the two sides of the first side plates 4312 of the first power division isolator 43. In this way, both the first substrate 4311 and the two first side plates 4312 of the first power division isolator 43 can isolate the signal transmission body 13 of the first power division feedline 10. In other words, the first power division isolation part 431 can provide isolation in three directions for the signal transmission body 13. When the feeding structure 102 is used, the feeding structure 102 may be fastened to the circuit board over the phase-shifting power division network 101, so that the circuit board and the first substrate 4311 and the two first side plates 4312 of the first power division isolation part 431 can provide isolation in four directions for the signal transmission body 13, thereby further reducing the radiation loss. In addition, a structure form between the signal transmission body 13 and the first power division isolation part 431 is a quasi-coaxial structure.

As shown in FIG. 6, the signal transmission body 13 of the second power division feedline 20 is fastened to the first power division isolation part 431 of the second power division isolator 44. For example, the signal transmission body 13 of the second power division feedline 20 is fastened between the first substrate 4311 and the two sides of the first side plates 4312 of the second power division isolator 44.

As shown in FIG. 6, both the extension bodies 14 on the two sides of the first power division feedline 10 are fastened to the second power division isolation part 432 of the first power division isolator 43. For example, the extension body 14 is located between the second substrate 4321 and the second side plates 4322 of the second power division isolation part 432. In this way, both the second substrate 4321 and the two second side plates 4322 can isolate the extension body 14. In other words, the second power division isolation part 432 can provide isolation in three directions for the extension body 14. When the feeding structure 102 is used, the feeding structure 102 may be fastened to the circuit board over the phase-shifting power division network 101, so that the circuit board and the second substrate 4321 and the two second side plates 4322 of the second power division isolation part 432 can provide isolation in four directions for the extension body 14, thereby further reducing the radiation loss. In addition, a structure form between the extension body 14 and the second power division isolation part 432 is a quasi-coaxial structure. Similarly, both the extension bodies 14 on the two sides of the second power division feedline 20 are fastened to the second power division isolation part 432 of the second power division isolator 44.

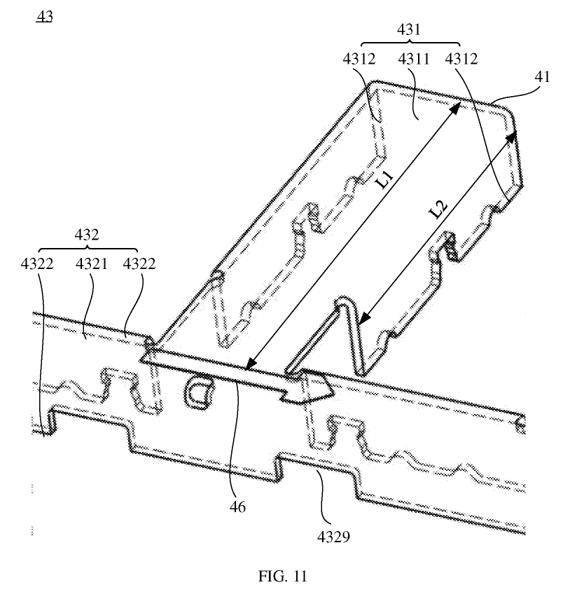

In this embodiment, the first power division isolator 43 may be of an integrally formed structure, and the second power division isolator 44 may also be of an integrally formed structure. In this way, to facilitate bending of the second power division isolator 44 to form the two first side plates 4312, as shown in FIG. 11, a length L2 of the first side plate 4312 is less than a length L1 of the first substrate 4311, and an end that is of the first side plate 4312 and that is away from the second power division isolation part 432 is aligned with the first substrate 4311. In other words, if there is a gap between the first side plate 4312 and the first power division isolator 43, the second power division isolator 44 cannot provide isolation for the signal transmission body 13 at the gap. Based on this, an end that is of the signal transmission body 13 and that is close to the extension body 14 is closer to the first substrate 4311 than an end that is of the signal transmission body 13 and that is away from the extension body 14. In other words, the signal transmission body 13 is closer to the first substrate 4311. The end that is of the signal transmission body 13 and that is away from the extension body 14 needs to be connected to the circuit board over the phase-shifting power division network 101. When the signal transmission body 13 is closer to the first substrate 4311, it can be ensured that the end that is of the signal transmission body 13 and that is away from the extension body 14 is connected to the circuit board over the phase-shifting power division network 101, and the first substrate 4311 can provide better isolation for a part that is of the signal transmission body 13 and that is closer to the first substrate 4311.

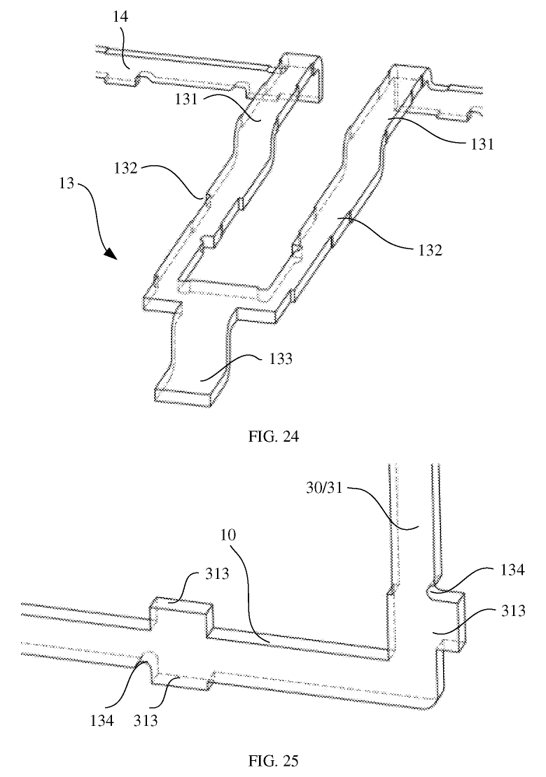

Further, as shown in FIG. 23 and FIG. 24, the signal transmission body 13 includes two first connection parts 131, two second connection parts 132, and a signal input/output part 133. The two first connection parts 131 are separately connected to the signal input/output part 133 via the two second connection parts 132. The two first connection parts 131 are respectively connected to the two extension bodies 14, and a distance between the second connection part 132 and the first substrate 4311 is less than a distance between the first connection part 131 and the first substrate 4311 and is greater than a distance between the signal input/output part 133 and the first substrate 4311. The first connection part 131 corresponds to the gap, and the first connection part 131 is closest to the first substrate 4311, so that isolation of the first substrate 4311 on the first connection part 131 can be improved. The signal input/output part 133 is farthest away from the first substrate 4311, that is, the signal input/output part 133 is closest to the bottom of the feeding structure 102, so that the signal input/output part 133 is connected to the circuit board over the phase-shifting power division network 101. The second connection part 132 further connects the first connection part 131 to the signal input/output part 133, and when the distance between the second connection part 132 and the first substrate 4311 is greater than the distance between the first connection part 131 and the first substrate 4311 and is less than the distance between the signal input/output part 133 and the first substrate 4311, the second connection part 132 may be located in the middle of the first side plate 4312, so that isolation of the second power division isolation part 432 on the signal transmission body 13 is good.

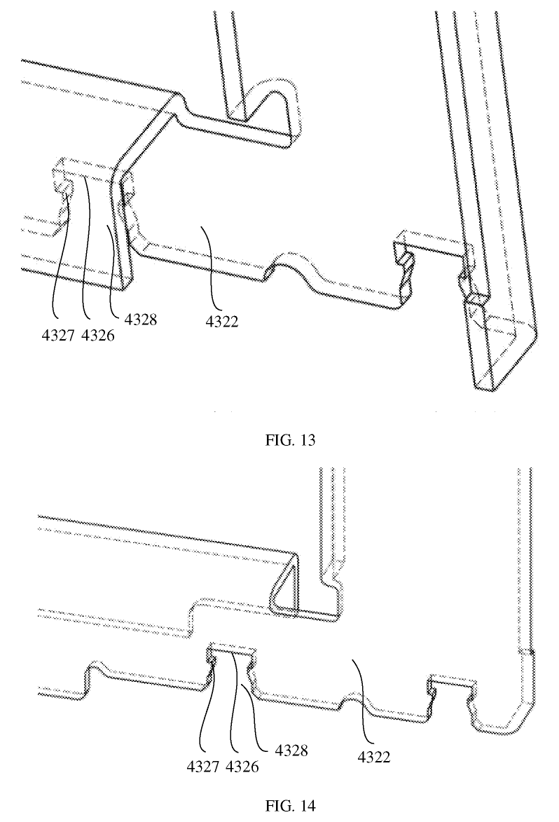

As shown in FIG. 13 and FIG. 14, a connection groove 4326 is disposed on the side that is of the second side plate 4322 and that is away from the second substrate 4321, and the connection groove 4326 is disposed on second side plates 4322 that are on the first power division isolator 43 and the second power division isolator 44 and that are away from each other. A protrusion 4327 is disposed on a groove wall of the connection groove 4326, and the protrusion 4327 and the groove wall form a clamping space 4328.

As shown in FIG. 6, the feeding structure 102 may further include two first fasteners 61. As shown in FIG. 27, the first fastener 61 includes a fastening body 611, two clamping parts 612, and at least two hooks 613. The two clamping parts 612 are respectively fastened to two sides of the fastening body 611. Two parallel clamping grooves 6111 are further disposed on the fastening body 611, and the two hooks 613 are respectively fastened to groove walls of the two clamping grooves 6111.

The two first connection parts 131 or the two second connection parts 132 of the signal transmission body 13 shown in FIG. 23 may be respectively clamped into the clamping grooves 6111 shown in FIG. 27, and the first connection parts 131 or the second connection parts 132 are limited via the hooks 613. The two clamping parts 612 of the first fastener 61 are respectively clamped into connection grooves 4326 of the first power division isolator 43 and the second power division isolator 44 and are located in the clamping space 4328. In this way, the two first fasteners 61 may respectively fasten the signal transmission body 13 of the first power division feedline 10 and the signal transmission body 13 of the second power division feedline 20 to the first power division isolator 43 and the second power division isolator 44. This not only implements fastening between the signal input body and the first power division isolator 43, but also implements fastening between the first power division isolator 43 and the second power division isolator 44. In addition, a clamping connection manner is used, so that assembly is more convenient, and a connection is more reliable. The clamping part 612 is a boss or an elastic arm. Therefore, the clamping part 612 has a simple structure and is easy to implement.

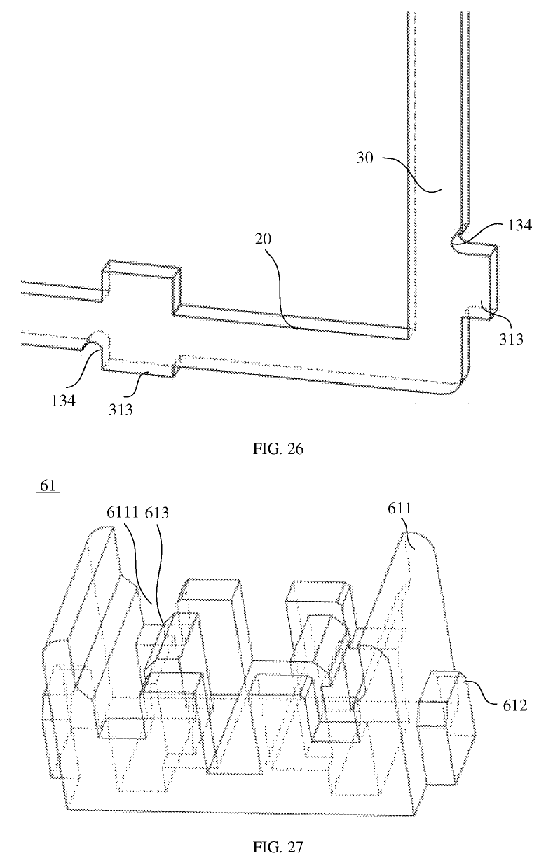

As shown in FIG. 25 and FIG. 26, a limiting bump 313 and a limiting groove 134 are disposed on each of the first power division feedline 10 and the second power division feedline 20. The limiting bump 313 is clamped into the clamping groove 6111, and the hook 613 is clamped on the limiting bump 313 and is partially located in the limiting groove 134. In this way, the limiting bump 313 and the limiting groove 134 can limit the first fastener 61, so that the first power division feedline 10 and the second power division feedline 20 are fastened to the power division isolation member 40 via the first fastener 61.

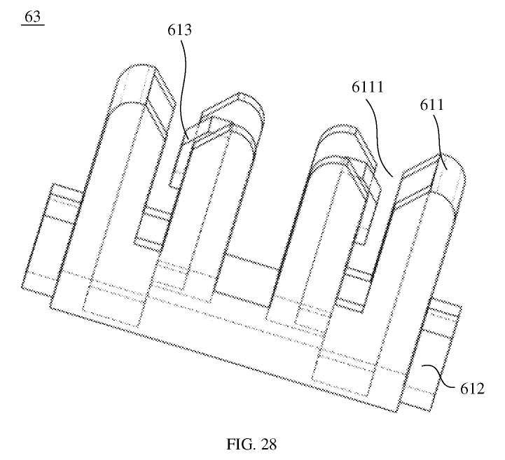

As shown in FIG. 6, the feeding structure 102 may further include three third fasteners 63 arranged in a length direction of the extension body 14. The third fastener 63 may fasten the extension body 14 to the first power division isolator 43 and the second power division isolator 44. A structure of the third fastener 63 is similar to that of the first fastener 61. As shown in FIG. 28, the third fastener 63 also includes a fastening body 611, two clamping parts 612, and at least two hooks 613. The two clamping parts 612 are respectively fastened to two sides of the fastening body 611. Two parallel clamping grooves 6111 are further disposed on the fastening body 611, and the two hooks 613 are respectively fastened to groove walls of the two clamping grooves 6111. The extension body 14 shown in FIG. 6 is fastened to the first power division isolator 43 and the second power division isolator 44 via the third fastener 63. In addition, a connection manner between the extension body 14, the third fastener 63, the first power division isolator 43, and the second power division isolator 44 is the same as a connection manner between the first fastener 61, the first power division feedline 10, the second power division feedline 20, the first power division isolator 43, and the second power division isolator 44. Details are not described herein again.

As shown in FIG. 6, the feeding structure 102 may further include a fourth fastener 64. A structure of the fourth fastener 64 is similar to that of the first fastener 61. The fourth fastener 64 also includes a fastening body 611, two clamping parts 612, and at least two hooks 613. The two clamping parts 612 are respectively fastened to two sides of the fastening body 611. Two parallel clamping grooves 6111 are further disposed on the fastening body 611, and the two hooks 613 are respectively fastened to groove walls of the two clamping grooves 6111. The balun 30 is fastened to the balun isolation member 50 via the fourth fastener 64. In addition, a connection manner between the balun 30, the fourth fastener 64, the first power division isolator 43, and the second power division isolator 44 is the same as the connection manner between the first fastener 61, the first power division feedline 10, the second power division feedline 20, the first power division isolator 43, and the second power division isolator 44. Details are not described herein again.

In addition, as shown in FIG. 11, an avoidance groove 4329 is disposed at the bottom of each of two first side plates 4312 that are on the first power division isolator 43 and the second power division isolator 44 and that are away from each other, to avoid the third fastener 63 shown in FIG. 6.

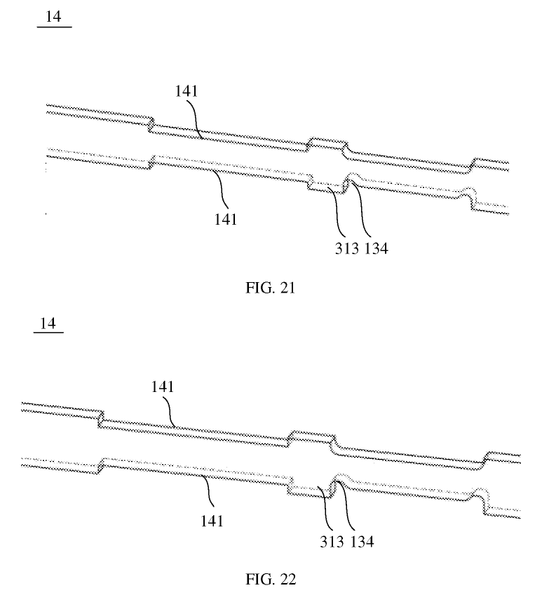

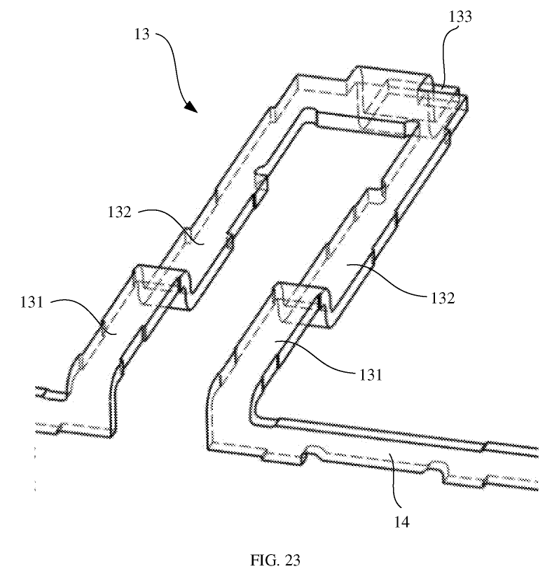

As shown in FIG. 21 and FIG. 22, grooves 141 at corresponding locations are disposed on two opposite side surfaces of the extension body 14, so that the grooves 141 on the extension body 14 can implement impedance matching. In another possible implementation, grooves at corresponding locations are disposed on two opposite side surfaces of the feeding body 31, so that the grooves on the feeding body 31 can implement impedance matching.

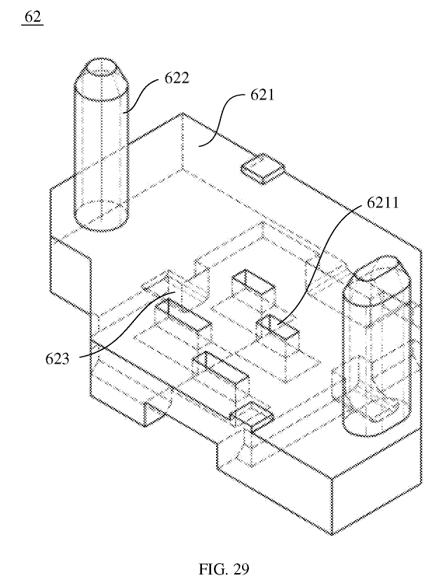

As shown in FIG. 6, the feeding structure 102 may further include a second fastener 62. As shown in FIG. 29, the second fastener 62 includes a fastening plate 621, a guide body 622 fastened to the top of the fastening plate 621, and a boss 623 fastened to the bottom of the fastening plate 621. A plurality of through holes 6211 are disposed on the fastening plate 621, and the fastening plate 621 is fastened to the balun 30 and the balun isolation member 50 shown in FIG. 6. A part of the feeding pin 32 and a part of the isolation pin 52 shown in FIG. 6 both penetrate the through hole 6211 and extend out of the fastening plate 621.

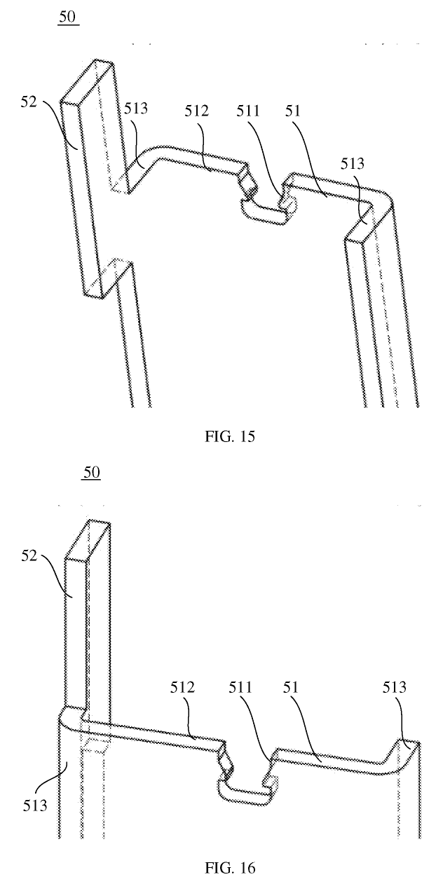

As shown in FIG. 15 and FIG. 16, a hook groove 511 is disposed on the top of each balun isolation member 50. The hook groove 511 may be a groove in which a hook is disposed on a groove wall. In this way, the boss 623 of the second fastener 62 can be fastened to the hook groove 511. Therefore, the second fastener 62 can be fastened to the balun 30 and the balun isolation member 50, and the second fastener 62 can provide an auxiliary connection function for the balun 30 and the balun isolation member 50.

In addition, a guide hole may be usually disposed on a bottom surface of the antenna element 200 shown in FIG. 4. In a process of mounting the antenna element 200 on the feeding structure 102, a mounting location of the antenna on the feeding structure 102 can be positioned via the guide body 622 and the guide hole, to implement quick positioning. In addition, if there is no guide body 622, the mounting location of the antenna element 200 needs to be positioned via the feeding pin 32 and the isolation pin 52, which causes the feeding pin 32 or the isolation pin 52 to be damaged. Therefore, the feeding pin 32 and the isolation pin 52 can be further protected by disposing the guide body 622.

As shown in FIG. 6, the feeding structure 102 further includes a first phase shift part 70. The first phase shift part 70 is fastened between the first power division feedline 10 and the power division isolation member 40, the first phase shift part 70 is further fastened between the second power division feedline 20 and the power division isolation member 40, and the first phase shift part 70 is configured to separately perform phase shift processing on signals transmitted on the first power division feedline 10 and the second power division feedline 20.

As shown in FIG. 31, the first phase shift part 70 includes a phase shift body 71, a plurality of baffles 72, a plurality of bosses 623, and a plurality of clamping parts 612, and two parallel phase shift grooves 711 are disposed on the phase shift body 71. The extension body 14 shown in FIG. 17 is located in the phase shift groove 711, and a space and a groove wall in the phase shift groove 711 can perform phase shift processing on a signal transmitted on the extension body 14. Four clamping grooves 6111 are further disposed on the phase shift body 71, two clamping grooves 6111 are located at one end of the phase shift groove 711, the other two clamping grooves 6111 are located at the other end of the phase shift groove 711, and the plurality of clamping parts 612 are respectively on groove walls of the clamping grooves 6111. The extension body 14 shown in FIG. 17 may be clamped into the clamping groove 6111 via the clamping part 612.

As shown in FIG. 31, some of the plurality of baffles 72 are located between the phase shift groove 711 and the clamping groove 6111 at one end, and the other baffles 72 are located between the phase shift groove 711 and the clamping groove 6111 at the other end. The baffle 72 abuts against the extension body 14 shown in FIG. 17, to limit the extension body 14.

In this way, the first phase shift part 70 can not only fasten the second power division feedline 20 to the power division isolation member 40, but also has a phase shift function. In addition, the first phase shift part 70 is located on one side of the signal transmission body 13, that is, a first phase shifter 1021 performs phase shift processing only on a signal transmitted by an extension body 14 located on one side of the signal transmission body 13. In this way, a preset phase of the signal transmitted by the extension body 14 on the one side relative to a signal transmitted by an extension body 14 on the other side is implemented, thereby implementing a preset downtilt of an antenna radiation beam. It may be understood that a connection manner between the first phase shift part 70, the power division isolation member 40, the first power division feedline 10, and the second power division feedline 20 is the same as a connection manner between the first fastener 61, the power division isolation member 40, the first power division feedline 10, and the second power division feedline 20. Details are not described herein again.

As shown in FIG. 6, the feeding structure 102 further includes a second phase shift part 80, the second phase shift part 80 and the first phase shift part 70 are located on a same side of the signal transmission body 13, the balun 30 is fastened to the balun isolation member 50 via the second phase shift part 80, and the second phase shift part 80 is configured to perform phase shift processing on a signal transmitted on the balun 30.

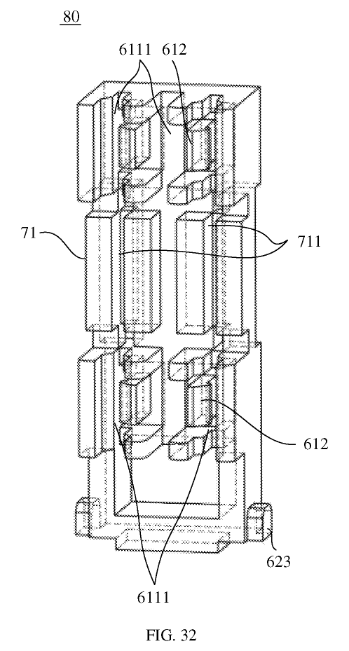

As shown in FIG. 32, the second phase shift part 80 includes a phase shift body 71, clamping parts 612, and bosses 623. The bosses 623 are disposed on two sides of the phase shift body 71. Phase shift grooves 711 are disposed on the phase shift body 71. The balun 30 is located in the phase shift groove 711, and a space and a groove wall in the phase shift groove 711 can perform phase shift processing on the signal transmitted on the balun 30. Four clamping grooves 6111 are further disposed on the phase shift body 71, two clamping grooves 6111 are located at one end of the phase shift groove 711, and the other two clamping grooves 6111 are located at the other end of the phase shift groove 711. The clamping part 612 is located in the clamping groove 6111, and the protrusion 4327 on the balun 30 is clamped into the clamping groove 6111 via the clamping part 612.

A phase shift amount of a phase shift part is related to a length of the phase shift part in a signal transmission direction. Because the first fastener 61 is further fastened between the extension body 14 and the power division isolation member 40, a length of the extension body 14 in the signal transmission direction is limited, a length of the first phase shift part 70 is limited, and a phase shift amount of the first phase shift part 70 cannot meet a phase shift amount requirement. The second phase shift part 80 can perform phase shift processing on the signal that is transmitted from the extension body 14 to the balun 30 and that is transmitted on the balun 30. Because the first phase shift part 70 and the second phase shift part 80 are located on the same side of the signal transmission body 13, phase shift processing can be separately performed on the signal transmitted on the balun 30 via the first phase shift part 70 and the second phase shift part 80, and a phase shift amount of the feeding structure 102 is a sum of the phase shift amount of the first phase shift part 70 and a phase shift amount of the second phase shift part 80. In this case, the phase shift amount of the feeding structure 102 can be increased, thereby meeting the phase shift amount requirement.

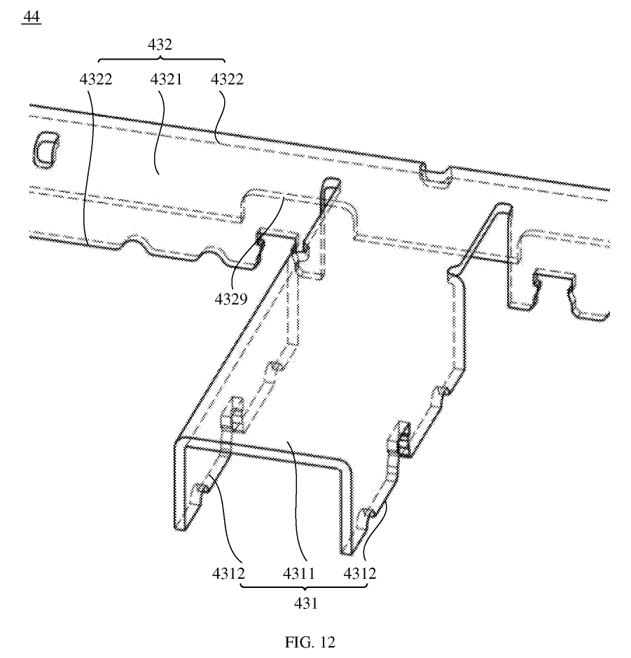

In addition, the first phase shift part 70 and the second phase shift part 80 are disposed on one side of the signal transmission body 13, and no phase shift part is disposed on the other side. Therefore, for ease of distinguishing directions, as shown in FIG. 11 and FIG. 12, an identification part 46 may be disposed on a side on which the first phase shifter 1021 on the power division isolation member 40 is located, to facilitate mounting.

As shown in FIG. 17 and FIG. 18, the feeding body 31 includes a first feeding part 311 connected to the first power division feedline 10 or the second power division feedline 20 and a second feeding part 312 connected to the first feeding part 311. The second feeding part 312 is connected to an end that is of the first feeding part 311 and that is away from the first power division feedline 10 or the second power division feedline 20. The feeding pin 32 is fastened to an end that is of the second feeding part 312 and that is away from the first feeding part 311. A width of the second feeding part 312 may be greater than a width of the first feeding part 311. The second phase shift part 80 shown in FIG. 6 may be fastened to the first feeding part 311 of the balun 30. Because both the second phase shift part 80 and the balun 30 are connected to the balun isolation space 53 of the balun isolation member 50 shown in FIG. 6, when the width of the second feeding part 312 is less than the width of the first feeding part 311, a sufficient space can be provided for mounting the second phase shift part 80.

As shown in FIG. 17, lengths of two baluns 30 connected to the first power division feedline 10 may be the same, and lengths of the first feeding part 311 and the second feeding part 312 may be different. Because the second phase shift part 80 is fastened to only one of the baluns, namely, a balun 30a, a length of a second feeding part 312 of a balun 30b not fastened to the second phase shift part 80 may be greater than a length of a second feeding part 312 of the balun 30a fastened to the second phase shift part 80.

As shown in FIG. 25 and FIG. 26, the feeding body 31 may further include the limiting bump 313 fastened to the first feeding part 311. The second phase shift part 80 shown in FIG. 6 abuts against the limiting bump 313, so that the limiting bump 313 can limit the second phase shift part 80 shown in FIG. 6. In addition, to avoid low mounting precision of the second phase shift part 80 caused by interference between the second phase shift part 80 and the limiting bump 313, as shown in FIG. 25, the limiting groove 134 is further disposed on the first feeding part 311, and a groove wall of the limiting groove 134 is connected to a side wall of the limiting bump 313.

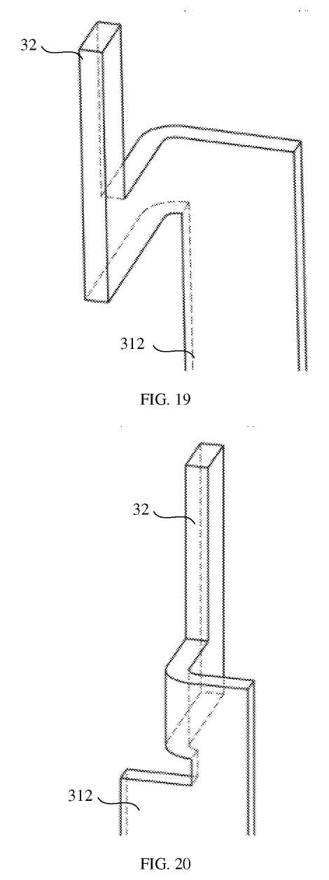

As shown in FIG. 19 and FIG. 20, the feeding pin 32 is in an "L" shape, and the feeding pin 32 is located on one side of the second feeding part 312. In addition, as shown in FIG. 17, connection directions of feeding pins 32 of the two baluns 30 that are connected to the first power division feedline 10 are the same, that is, the feeding pins 32 are located on a same side of the second feeding part 312.

As shown in FIG. 17, the first power division feedline 10 and the two baluns 30 that are fastened to the first power division feedline 10 form an integrally formed structure. In this way, the first power division feedline 10 and the two baluns 30 can be manufactured together, so that a manufacturing process of the feeding structure 102 can be simplified. Similarly, as shown in FIG. 18, the second power division feedline 20 and the two baluns 30 that are fastened to the second power division feedline 20 form an integrally formed structure. In this way, the first power division feedline 10 and the two baluns 30 can be manufactured together, so that the manufacturing process of the feeding structure 102 can be simplified.

As shown in FIG. 6, a quantity of balun isolation members 50 is the same as a quantity of baluns 30. In this embodiment, there are four balun isolation members 50 and four baluns 30. As shown in FIG. 15, the isolation body 51 includes a third substrate 512 and third side plates 513 located on two sides of the third substrate 512. The third substrate 512 and the two third side plates 513 may form a "U"-shaped structure.

As shown in FIG. 7, two balun isolation members 50 are fastened to two ends of the first power division isolator 43, and the first power division isolation part 431 and the two balun isolation members 50 that are fastened to the first power division isolator 43 form an integrally formed structure. For example, the first power division isolator 43 and the two balun isolation members 50 may be manufactured by cutting or bending sheet metal. In this way, the first power division isolator 43 and the two balun isolation members 50 can be manufactured together, so that the manufacturing process of the feeding structure 102 can be simplified.

As shown in FIG. 8, the other two balun isolation members 50 are fastened to two ends of the second power division isolator 44, and the second power division isolator 44 and the two balun isolation members 50 that are fastened to the second power division isolator 44 form an integrally formed structure. For example, the second power division isolator 44 and the two balun isolation members 50 may be manufactured by cutting or bending sheet metal. In this way, the second power division isolator 44 and the two balun isolation members 50 can be manufactured together, so that the manufacturing process of the feeding structure 102 can be simplified.

As shown in FIG. 6, two balun isolation members 50 located on a same side of the first power division feedline 10 and the second power division feedline 20 are disposed opposite to each other, that is, third side plates 513 are disposed in opposite directions. In this way, the balun isolation space 53 can be formed between the two third substrates 512 and the four third side plates 513. Two baluns 30 located on a same side of the first power division feedline 10 and the second power division feedline 20 are both located in a balun isolation space 53 on the same side as the two baluns.

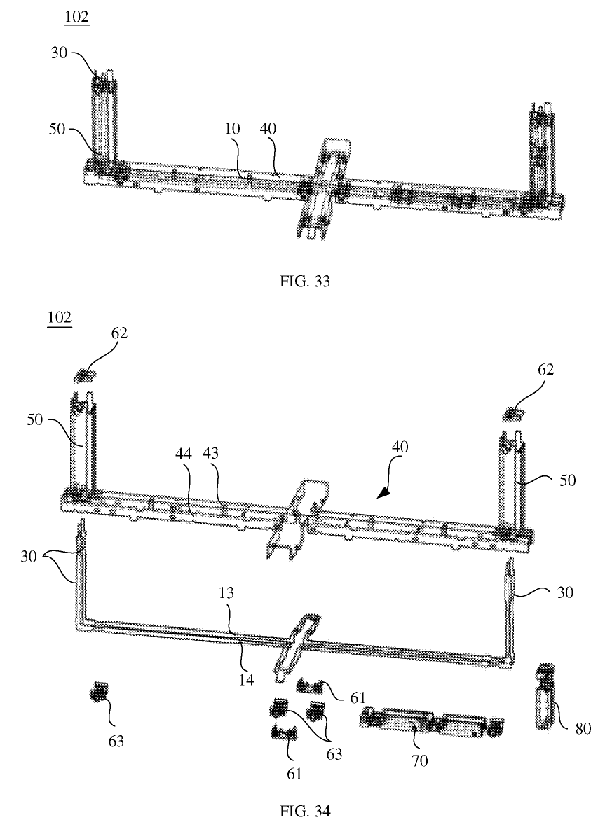

In another embodiment of this disclosure, as shown in FIG. 33 and FIG. 34, a difference from the embodiment shown in FIG. 6 lies in that a structure of the power division isolation member 40, a quantity of baluns 30 and a structure thereof, a quantity of balun isolation members 50 and a structure thereof, a manufacturing manner of the feeding structure 102, and structures of the first fastener 61, the second fastener 62, the third fastener 63, the first phase shift part 70, and the second phase shift part 80 are different.

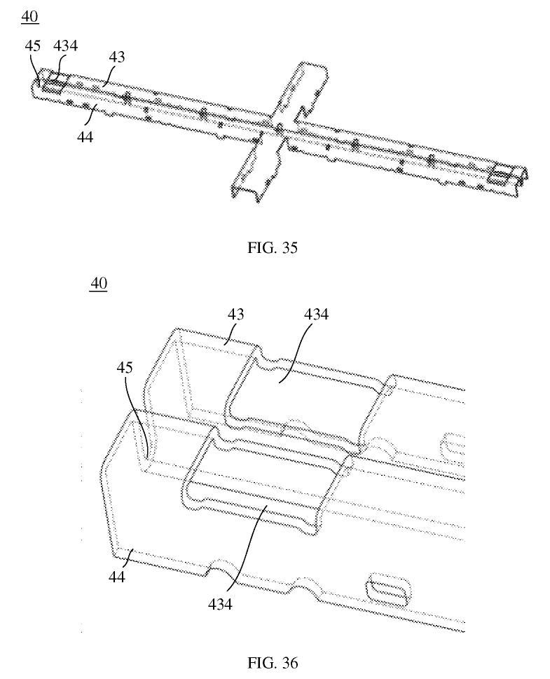

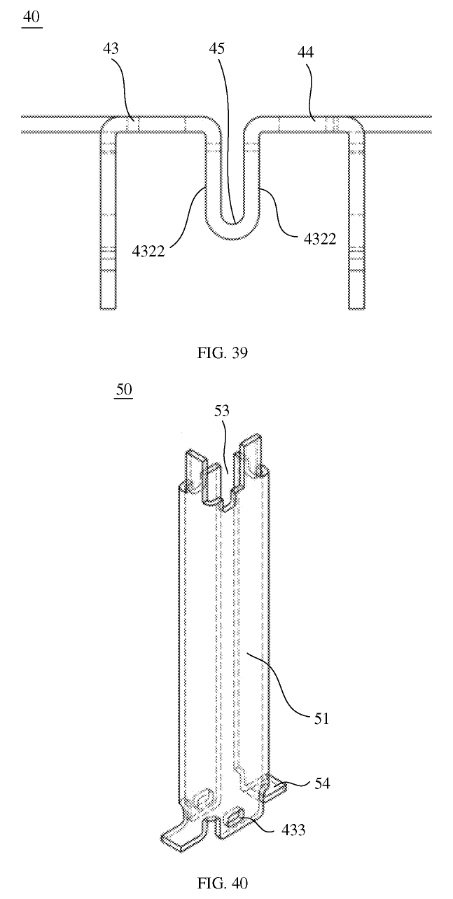

In this embodiment, as shown in FIG. 36 and FIG. 39, in addition to the first power division isolator 43 and the second power division isolator 44, the power division isolation member 40 may further include a connection plate 45. As shown in FIG. 39, there is a distance between the two second side plates 4322 that are on the first power division isolator 43 and the second power division isolator 44 and that are close to each other, and the two second side plates 4322 are connected via the connection plate 45. In addition, as shown in FIG. 35 and FIG. 38, the power division isolation member 40 may be of an integrally formed structure. In this way, strength of the power division isolation member 40 can be improved. The connection plate 45 may be a curved plate, so that the power division isolation member 40 can be manufactured by using a bending process.

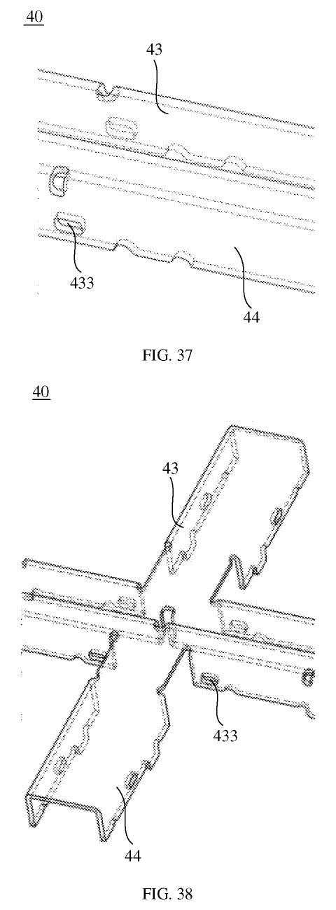

As shown in FIG. 36, top openings 434 are disposed at opposite locations of the first power division isolator 43 and the second power division isolator 44, and the balun 30 may pass through the bottom of the top opening 434 to extend out of the top. As shown in FIG. 37, side openings 433 are further disposed on the first side plates 4312 that are on the first power division isolator 43 and the second power division isolator 44 and that are away from each other, to avoid the first fastener 61 or the first phase shifter 1021.

As shown in FIG. 34, there are two balun isolation members 50. As shown in FIG. 40, a cross section of the isolation body 51 of each balun isolation member 50 is a ring-shaped cross section having an opening. In this way, a balun isolation space 53 can be formed inside each balun isolation member 50, and the balun isolation member 50 may use an integrally formed structure, so that strength of the balun isolation member 50 can be improved. As shown in FIG. 34, two baluns 30 located on one side of the first power division feedline 10 and the second power division feedline 20 are located in a balun isolation space 53 formed in one of the balun isolation members 50, and two baluns 30 located on the other side of the first power division feedline 10 and the second power division feedline 20 are located in a balun isolation space 53 formed in the other balun isolation member 50.

As shown in FIG. 40, the balun isolation member 50 may further include an isolation soldering pin 54 located at an end that is of the isolation body 51 and that is close to the first power division feedline 10 shown in FIG. 34. The isolation soldering pin 54 is of a plate-shaped structure, and there is an included angle between an extension direction of the isolation soldering pin 54 and an extension direction of the isolation body 51. The isolation soldering pin 54 may be fastened to the power division isolation member 40 shown in FIG. 34.

The side openings 433 are further disposed on two opposite surfaces of the balun isolation member 50, to avoid the first phase shift part 70 shown in FIG. 34.

Each balun isolation member 50 is of an integrally formed structure. Each balun isolation member 50 is soldered to the power division isolation member 40 by using soldering tin.

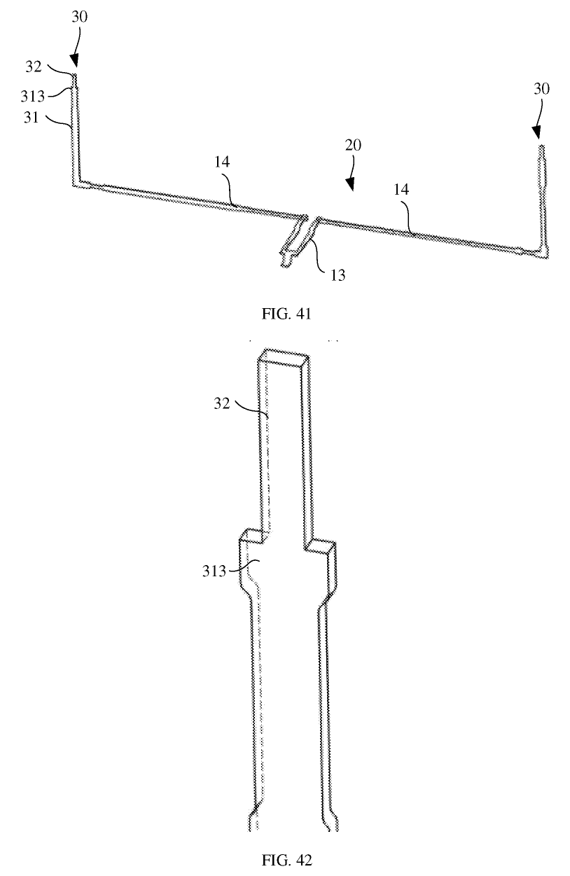

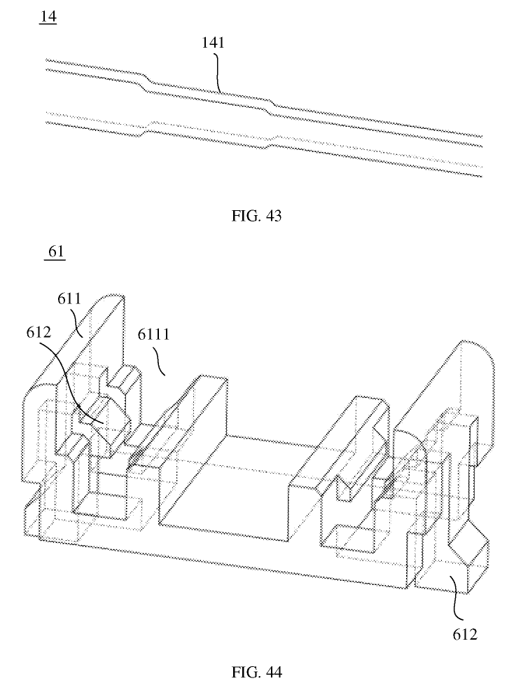

As shown in FIG. 41 and FIG. 42, the feeding pin 32 of the balun 30 extends along a straight line, and the opposite limiting bump 313 is disposed. As shown in FIG. 43, the grooves 141 at the corresponding locations are disposed on the two opposite side surfaces of the extension body 14 of the balun 30, so that impedance matching can be implemented.

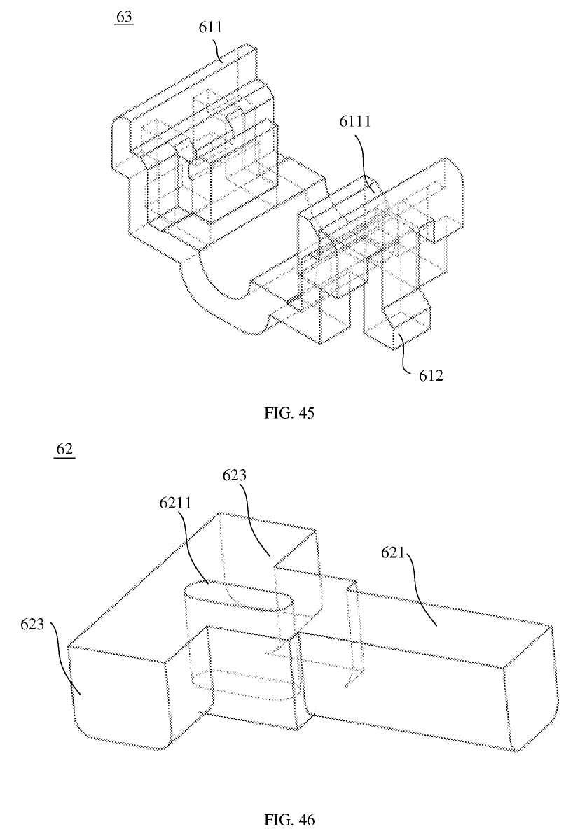

The clamping part 612 on the first fastener 61 shown in FIG. 44 and the clamping part 612 on the third fastener 63 shown in FIG. 45 are of elastic arm structures. As shown in FIG. 34, there are four second fasteners 62. Two second fasteners 62 are fastened to one balun isolation member 50, and the other two second fasteners 62 are fastened to the other balun isolation member 50. As shown in FIG. 46, the second fastener 62 includes the fastening plate 621 and the bosses 623 extending from two sides of the fastening plate 621. The through hole 6211 is disposed on the second fastener 62.

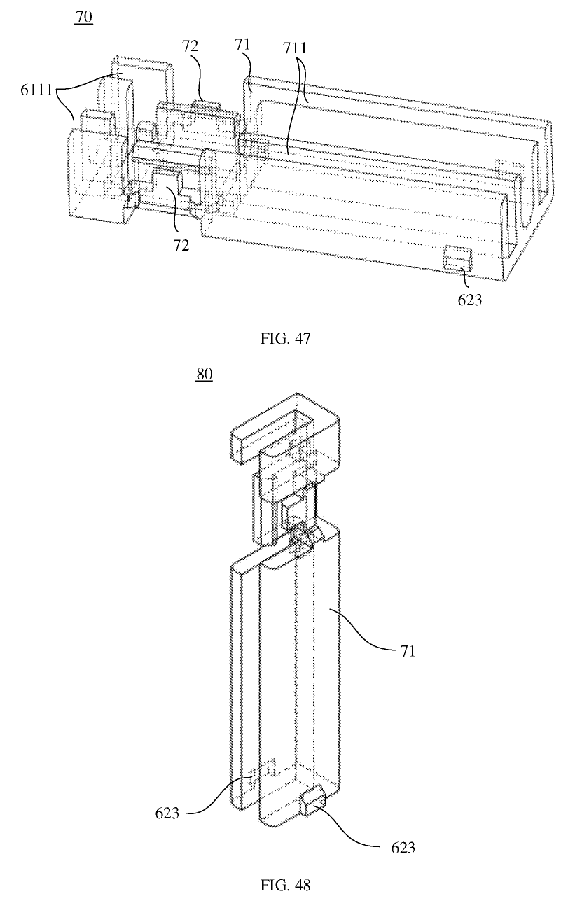

As shown in FIG. 34, there are two first phase shift parts 70, and the two first phase shift parts 70 are connected in a length direction. As shown in FIG. 47, there are two clamping grooves 6111 on the first phase shift part 70, and there are also two baffles 72.

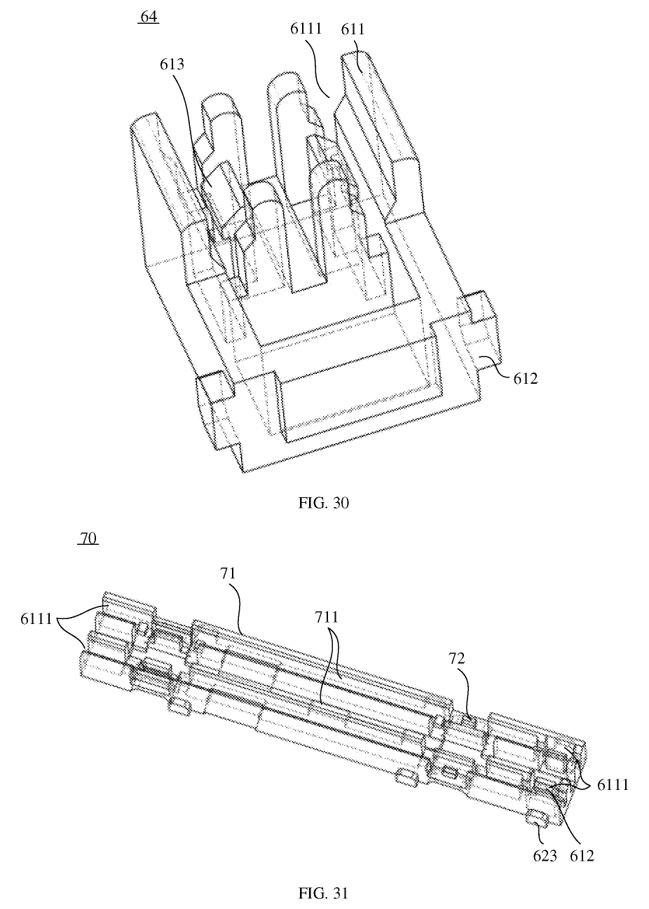

As shown in FIG. 30, there are two second phase shift parts 80, and the two second phase shift parts 80 are disposed side by side. One second phase shift part 80 is connected to one of the two baluns 30 on a same side, and the other second phase shift part 80 is connected to the other balun 30. As shown in FIG. 48, the bosses 623 are disposed on the two sides of the phase shift body 71 of the second phase shift part 80, to be fastened to the second side plates 4322 of the first power division isolator 43 and the second power division isolator 44 shown in FIG. 34.

The foregoing describes embodiments of this disclosure with reference to the accompanying drawings. However, this disclosure is not limited to the foregoing specific implementations. The foregoing specific implementations are merely examples, but are not limitative. Inspired by this disclosure, a person of ordinary skill in the art may further make many modifications without departing from the purposes of this disclosure and the protection scope of the claims, and all the modifications shall fall within the protection scope of this disclosure.

1. A feeding structure, comprising:
a first power division feedline, wherein the first power division feedline has a first port and at least two second ports;
at least two baluns, wherein each balun comprises a feeding body and a feeding pin, the feeding bodies of the at least two baluns are respectively connected to the at least two second ports, and the feeding pin is disposed at an end that is of the feeding body and that is away from the second port;
a power division isolation member, wherein a first power division isolation space is formed on the power division isolation member, and the first power division feedline is fastened to the first power division isolation member and is located in the first power division isolation space; and
a balun isolation member, wherein a balun isolation space is formed on the balun isolation member, and the feeding body is fastened to the balun isolation member and is located in the balun isolation space.

2. The feeding structure according to claim 1, wherein the feeding structure further comprises a second power division feedline, the second power division feedline has a first port and at least two second ports, a feeding body of a part of the at least two baluns is connected to the second port of the first power division feedline, and a feeding body of the other part of the baluns is connected to the second port of the second power division feedline; and
a second power division isolation space is formed on the power division isolation member, and the second power division feedline is fastened to the power division isolation member and is located in the second power division isolation space.

3. The feeding structure according to claim 2, wherein the power division isolation member comprises a first power division isolator and a second power division isolator, the first power division isolation space is formed on the first power division isolator, the second power division isolation space is formed on the second power division isolator, and the first power division isolator and the second power division isolator are disposed side by side.

4. The feeding structure according to claim 3, wherein the first power division isolator and the second power division isolator each comprise a first power division isolation part and a second power division isolation part that is disposed on the first power division isolation part and that forms, in an extension direction, an included angle with the first power division isolation part; and
the first power division feedline and the second power division feedline each comprise a signal transmission body and extension bodies respectively extending from two sides of the signal transmission body, the signal transmission bodies of the first power division feedline and the second power division feedline are respectively fastened to the first power division isolation parts of the first power division isolator and the second power division isolator, and the extension bodies of the first power division feedline and the second power division feedline are respectively fastened to the second power division isolation parts of the first power division isolator and the second power division isolator.

5. The feeding structure according to claim 4, wherein the first power division isolation part comprises a first substrate and first side plates fastened to two sides of the first substrate, and the signal transmission body is located between the first substrate and the first side plates on the two sides; and/or
the second power division isolation part comprises a second substrate and second side plates fastened to two sides of the second substrate, and the extension body is located between the second substrate and the second side plates of the second power division isolation part.

6. The feeding structure according to claim 5, wherein two second side plates that are on the first power division isolator and the second power division isolator and that are close to each other are in contact and connected.

7. The feeding structure according to claim 5, wherein the power division isolation member further comprises a connection plate, there is a distance between two second side plates that are on the first power division isolator and the second power division isolator and that are close to each other, and the two second side plates are connected via the connection plate.

8. The feeding structure according to claim 7, wherein the power division isolation member is of an integrally formed structure.

9. The feeding structure according to claim 5, wherein a length of the first side plate is less than a length of the first substrate, and an end that is of the first side plate and that is away from the second power division isolation part is aligned with the first substrate; and
an end that is of the signal transmission body and that is close to the extension body is closer to the first substrate than an end that is of the signal transmission body and that is away from the extension body.

10. The feeding structure according to claim 5, wherein the signal transmission body comprises a first connection part, a second connection part, and a signal input/output part that are sequentially connected, the first connection part is connected to the extension body, and a distance between the second connection part and the first substrate is less than a distance between the first connection part and the first substrate and is greater than a distance between the signal input/output part and the first substrate.

11. The feeding structure according to claim 5, wherein a plurality of accommodation grooves are disposed on each of second side plates of the first power division isolator and the second power division isolator, a bottom pin is formed between two adjacent accommodation grooves on a same second side plate, and the accommodation groove is disposed on a side that is of the second side plate and that is away from the second substrate.

12. The feeding structure according to claim 5, wherein a connection groove is disposed on the side that is of the second side plate and that is away from the second substrate, a protrusion is disposed on a groove wall of the connection groove, and the protrusion and the groove wall form a clamping space;
the feeding structure further comprises a first fastener, and the first fastener comprises a fastening body and a clamping part fastened to the fastening body; and
the first power division feedline and/or the second power division feedline are/is fastened to the first power division isolator and the second power division isolator via the first fastener, and the clamping part is clamped into the connection groove and is located in the clamping space.

13. The feeding structure according to claim 12, wherein the clamping part is a boss or an elastic arm.

14. The feeding structure according to claim 4, wherein grooves at corresponding locations are disposed on two opposite side surfaces of the extension body, or grooves at corresponding locations are disposed on two opposite side surfaces of the feeding body.

15. The feeding structure according to claim 12, wherein a limiting bump and a limiting groove are disposed on each of the first power division feedline and the second power division feedline; and
a clamping groove is formed on the fastening body, the first fastener further comprises a hook fastened to a groove wall of the clamping groove, the limiting bump is located in the clamping groove, and the hook is clamped on the limiting bump and is partially located in the limiting groove.

16. The feeding structure according to claim 1, wherein the feeding structure further comprises a second fastener, the second fastener comprises a fastening plate and a guide body fastened to the fastening plate, a plurality of through holes are disposed on the fastening plate, the fastening plate is fastened to the balun, and a part of the feeding pin penetrates the through hole and extends out of the fastening plate.

17. The feeding structure according to claim 2, wherein the first power division feedline and the second power division feedline each comprise the signal transmission body and the extension bodies respectively extending from the two sides of the signal transmission body; and
the feeding structure further comprises a first phase shift part located on one side of the signal transmission body, the first phase shift part is fastened between the first power division feedline and the power division isolation member, the first phase shift part is further fastened between the second power division feedline and the power division isolation member, and the first phase shift part is configured to separately perform phase shift processing on signals transmitted on the first power division feedline and the second power division feedline.

18. The feeding structure according to claim 17, wherein the feeding structure further comprises a second phase shift part, the second phase shift part and the first phase shift part are located on a same side of the signal transmission body, the balun is fastened to the balun isolation member via the second phase shift part, and the second phase shift part is configured to perform phase shift processing on a signal transmitted on the balun.

19. A feeding network, comprising a circuit board, a phase-shifting power division network, and a feeding structure, wherein the feeding structure comprises:
a first power division feedline, wherein the first power division feedline has a first port and at least two second ports;
at least two baluns, wherein each balun comprises a feeding body and a feeding pin, the feeding bodies of the at least two baluns are respectively connected to the at least two second ports, and the feeding pin is disposed at an end that is of the feeding body and that is away from the second port;
a power division isolation member, wherein a first power division isolation space is formed on the power division isolation member, and the first power division feedline is fastened to the first power division isolation member and is located in the first power division isolation space; and
a balun isolation member, wherein a balun isolation space is formed on the balun isolation member, and the feeding body is fastened to the balun isolation member and is located in the balun isolation space; and
wherein the phase-shifting power division network is electrically connected to the circuit board, and the feeding structure is electrically connected to the phase-shifting power division network.

20. An antenna, comprising a plurality of antenna elements and a feeding network, wherein the feeding network comprises a circuit board, a phase-shifting power division network, and thea feeding structure according to claim 1, wherein the feeding structure comprises:
a first power division feedline, wherein the first power division feedline has a first port and at least two second ports;
at least two baluns, wherein each balun comprises a feeding body and a feeding pin, the feeding bodies of the at least two baluns are respectively connected to the at least two second ports, and the feeding pin is disposed at an end that is of the feeding body and that is away from the second port;
a power division isolation member, wherein a first power division isolation space is formed on the power division isolation member, and the first power division feedline is fastened to the first power division isolation member and is located in the first power division isolation space; and
a balun isolation member, wherein a balun isolation space is formed on the balun isolation member, and the feeding body is fastened to the balun isolation member and is located in the balun isolation space; and
wherein the phase-shifting power division network is electrically connected to the circuit board, and the feeding structure is electrically connected to the phase-shifting power division network; and
wherein the antenna element is electrically connected to the feeding network.
